(19) United States
(12) Patent Application Publication
(10) Pub. No.: US 2024/0220908 A1
(43) Pub. Date: Jul. 4, 2024

(54) METHODS, APPARATUS, AND SYSTEM FOR MONITORING TEAM HEALTH METRICS AND TRAINING A CONTEXTUALLY TRIGGERED TEAM IMPROVEMENT ENGINE

(71) Applicants: ATLASSIAN PTY LTD., Sydney (AU); ATLASSIAN (US) LLC, San Francisco, CA (US)

(72) Inventors: Martyn Glenn WINSEN, Sydney (AU); Nicholas Paul ALESANDRO, San Francisco, CA (US)

(21) Appl. No.: 18/147,864

(22) Filed: Dec. 29, 2022

(51) Int. Cl. G06Q 10/0639; G06Q 10/10

(52) U.S. Cl. CPC G06Q 10/06398; G06Q 10/06393; G06Q 10/103; G06N 20/00

(57) ABSTRACT

Various embodiments of the present disclosure provide apparatuses, systems, computer-implemented methods, and computer program products for capturing collaborative work data in internal collaboration platforms and/or external collaboration platforms, determining team health metrics, and/or generating one or more team health metrics dashboards that are represented within a team assessment interface that is rendered to a client device. Such team assessment interfaces may be configured to display one or more team improvement insight components and one or more team improvement intervention components that are configured to encourage user engagement and to improve team health metrics. In still further embodiments, collaborative work data may be captured to generate team health training datasets, which are used to train machine learning models that can be used to configure a contextually triggered team improvement engine.

### BACKGROUND

Various methods, apparatuses, and systems provide tools for users to plan, collaborate, complete, and monitor projects and tasks in enterprise network systems. Applicant has identified a number of deficiencies and problems associated with efficiently and effectively monitoring team health and productivity, and providing metrics, statistics, suggestions, and/or recommendations for triggering team health interventions in enterprise network systems. Through applied effort, ingenuity and innovation, many of these identified deficiencies and problems have been solved by developing solutions that are structured in accordance with the embodiments of the present disclosure, many examples of which are described in detail herein.

### BRIEF SUMMARY

In general, embodiments of the present invention provide methods, apparatuses, systems, computing devices, and/or the like that are configured to effectively and efficiently configure a contextually triggered team improvement engine to operate in a collaborative enterprise platform. For example. certain embodiments of the present invention provide methods, apparatuses, systems, computing devices, and/or the like that

In one aspect, an apparatus for configuring a contextually triggered team improvement engine to operate in a collaborative enterprise platform includes at least one processor, and at least one memory including program code. The at least one memory and the program code are configured to, with the at least one processor, cause the apparatus to access external collaborative work data from a plurality of external collaboration platforms. The apparatus also includes program code configured to access internal collaborative work data from a plurality of internal collaboration platforms. The apparatus also includes program code configured to generate a team health training dataset based on the external collaborative work data and the internal collaborative work data. The apparatus also includes program code configured to train a machine learning model based on the team health training dataset to generate a trained team health improvement machine learning model. The apparatus also includes program code configured to configure the contextually triggered team improvement engine based on the trained team health improvement machine learning model.

The apparatus further includes where the team health training dataset is generated based on applying sentiment analysis operations and collaboration graph identification operations to the external collaborative work data and the internal collaborative work data.

The apparatus further includes where the collaboration graph identification operations are configured to generate a collaboration work graph based on the external collaborative work data and the internal collaborative work data, and the machine learning model is trained to generate the trained team health improvement machine learning model based at least in part on the collaboration work graph.

The apparatus further includes where at least one of the external collaborative work data or the internal collaborative work data comprises team survey data.

The apparatus further includes where the contextually triggered team improvement engine is configured to monitor user engagement with the collaborative enterprise platform and to generate team improvement insight components for outputting to a team assessment interface.

The apparatus further includes where the contextually triggered team improvement engine is configured to monitor user engagement with the collaborative enterprise platform and to generate a team improvement intervention component for outputting to a team member client device of the collaborative enterprise platform.

The apparatus further includes where the team improvement intervention component comprises a survey interface component that is configured for rendering to a team work interface displayed by the team member client device.

The apparatus further includes where the team improvement intervention component comprises a team improvement workflow interface component that is configured for rendering to a team work interface displayed by the team member client device.

The apparatus further includes where the contextually triggered team improvement engine is configured to compare a team health metrics set to a team health metric threshold set to generate a team health dashboard metrics set, and to output the team health dashboard metrics set for rendering to a team health dashboard interface of a team assessment interface.

In one aspect, a computer-implemented method for configuring a contextually triggered team improvement engine for operation in a collaborative enterprise platform includes accessing external collaborative work data from a plurality of external collaboration platforms. The computer-implemented method also includes accessing internal collaborative work data from a plurality of internal collaboration platforms. The computer-implemented method also includes generating a team health training dataset based on the external collaborative work data and the internal collaborative work data. The computer-implemented method also includes training a machine learning model based on the team health training dataset generating a trained team health improvement machine learning model. The computer-implemented method also includes configuring the contextually triggered team improvement engine based on the trained team health improvement machine learning model.

The computer-implemented method further includes generating the team health training dataset based on applying sentiment analysis operations and collaboration graph identification operations to the external collaborative work data and the internal collaborative work data.

The computer-implemented method further includes configuring the collaboration graph identification operations to generate a collaboration work graph based on the external collaborative work data and the internal collaborative work data, and training the machine learning model to generate the trained team health improvement machine learning model based at least in part on the collaboration work graph.

The computer-implemented method further includes at least one of the external collaborative work data or the internal collaborative work data comprises team survey data.

The computer-implemented method further includes configuring the contextually triggered team improvement engine to monitor user engagements with the collaborative enterprise platform and generates team improvement insight components for outputting to a team assessment interface.

The computer-implemented method further includes configuring the contextually triggered team improvement engine to monitor user engagements with the collaborative enterprise platform and generates a team improvement intervention component for outputting to a team member client device of the collaborative enterprise platform.

The computer-implemented method further includes configuring the team improvement intervention component comprising a survey interface component for rendering to a team work interface displaying on the team member client device.

The computer-implemented method further includes configuring the team improvement intervention component comprising a team improvement workflow interface component for rendering to a team work interface displaying on the team member client device.

The computer-implemented method further includes configuring the contextually triggered team improvement engine to compare a team health metrics set to a team health metric threshold set generating a team health dashboard metrics set, and outputting the team health dashboard metrics set for rendering to a team health dashboard interface of a team assessment interface.

In one aspect, a non-transitory computer-readable storage medium for configuring a contextually triggered team improvement engine for operation in a collaborative enterprise platform includes instructions that when executed by at least one processor, cause the at least one processor to access external collaborative work data from a plurality of external collaboration platforms. The non-transitory computer-readable storage medium also includes instructions configured to access internal collaborative work data from a plurality of internal collaboration platforms. The non-transitory computer-readable storage medium also includes instructions configured to generate a team health training dataset based on the external collaborative work data and the internal collaborative work data. The non-transitory computer-readable storage medium also includes instructions configured to train a machine learning model based on the team health training dataset to generate a trained team health improvement machine learning model. The non-transitory computer-readable storage medium also includes instructions configured to configure the contextually triggered team improvement engine based on the trained team health improvement machine learning model.

The non-transitory computer-readable storage medium further includes instructions configured to generate the team health training dataset based on applying sentiment analysis operations and collaboration graph identification operations to the external collaborative work data and the internal collaborative work data.

The non-transitory computer-readable storage medium further includes instructions configured to configure the collaboration graph identification operation to generate a collaboration work graph based on the external collaborative work data and the internal collaborative work data, and the machine learning model is trained to generate the trained team health improvement machine learning model based at least in part on the collaboration work graph.

The non-transitory computer-readable storage medium further includes instructions configured to configure at least one of the external collaborative work data or the internal collaborative work data comprise team survey data.

The non-transitory computer-readable storage medium further includes instructions configured to configure the contextually triggered team improvement engine to monitor user engagement with the collaborative enterprise platform and to generate team improvement insight components for outputting to a team assessment interface.

The non-transitory computer-readable storage medium further includes instructions configured to configure the contextually triggered team improvement engine to monitor user engagement with the collaborative enterprise platform and to generate a team improvement intervention component for outputting to a team member client device of the collaborative enterprise platform.

The non-transitory computer-readable storage medium further includes instructions configured to configure the team improvement intervention component comprises a survey interface component that is configured for rendering to a team work interface displayed by the team member client device.

The non-transitory computer-readable storage medium further includes instructions configured to configure the team improvement intervention component comprises a team improvement workflow interface component that is configured for rendering to a team work interface displayed by the team member client device.

The non-transitory computer-readable storage medium further includes instructions configured to configure the contextually triggered team improvement engine to compare a team health metrics set to a team health metric threshold set to generate a team health dashboard metrics set, and to output the team health dashboard metrics set for rendering to a team health dashboard interface of a team assessment interface.

The above summary is provided merely for purposes of summarizing some example embodiments to provide a basic understanding of some aspects of the present disclosure.

Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the drawing:

FIG. 1 illustrates an example collaborative enterprise platform configured to communicate with various internal platforms, external platforms, client devices, and repositories in accordance with various embodiments of the present disclosure;

FIG. 2 is a schematic block diagram of example circuitry of a collaborative enterprise platform that is configured to preform various operations in accordance with various embodiments of the present disclosure;

FIG. 3 is a schematic block diagram of example circuitry of an example user device in accordance with various embodiments of the present disclosure;

FIG. 4A is a flowchart illustrating example operations of a contextually triggered engine for collecting collaborative data in support training a machine learning model in accordance with various embodiments of the present disclosure;

FIG. 4B is a flowchart illustrating example operations of a contextually triggered engine for monitoring and updating team health metrics in accordance with various embodiments of the present disclosure;

FIG. 5A is a flowchart illustrating example operations for generating a team health training data set and training a machine learning model in accordance with various embodiments of the present disclosure;

FIG. 5B is a flowchart illustrating example operation for applying sentiment analysis in accordance with various embodiments of the present disclosure;

FIG. 6A is a chart illustrating example positive sentiment key words in accordance with various embodiments of the present disclosure;

FIG. 6B is a chart illustrating example negative sentiment key words in accordance with various embodiments of the present disclosure;

FIG. 7 is a flowchart illustrating example operations of a contextually triggered engine that is configured to generate a team improvement component and to update team health metrics in accordance with various embodiments of the present disclosure;

FIG. 8 illustrates an example team health metrics dashboard configured in accordance with various embodiments of the present disclosure;

FIG. 9A illustrates an example team health metrics dashboard configured in accordance with various embodiments of the present disclosure; and

FIG. 9B illustrates an example updated team health metrics dashboard configured in accordance with various embodiments of the present disclosure.

### DETAILED DESCRIPTION

One or more embodiments now will be more fully described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard). It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements. As used herein, the description may refer to a server or client device as an example “apparatus.” However, elements of the apparatus described herein may be equally applicable to the claimed system, method, and computer program product. Accordingly, use of any such terms should not be taken to limit the spirit and scope of embodiments of the present disclosure.

Methods, apparatuses, systems, and computer program products are provided in accordance with example embodiments of the present disclosure in order to address technical problems associated with monitoring and updating team health metrics in a collaborative enterprise platform in an efficient manner. A collaborative enterprise platform may be configured to monitor internal collaborative work data and external collaborative work data produced by user engagement with one or more internal collaboration platforms (e.g., Jira Software™, Jira Service Management™, Jira Work Management™, Confluence, Bitbucket™, Trello™, Statuspage™ Opsgenie™, Jira Align™, Halp™, and/or the like) and with one or more external collaboration platforms (e.g., Slack™, Microsoft Teams™, Gmail™, Microsoft Outlook™, Zendesk, SurveyMonkey™, Calendar etc.).

### Overview

Individuals and organizations routinely use internal collaboration platforms (e.g., Jira Software™, Jira Service Management™, Jira Work Management™, Confluence™, Bitbucket™ Trello™, Statuspage™, Opsgenie™, Jira Align™, Halp™, and/or the like) and external collaboration platforms (e.g., Slack™, Microsoft Teams™, Gmail™, Microsoft Outlook™ Zendesk™, SurveyMonkey™, Calendar etc.) to perform daily tasks for a project and/or for a team the individual is assigned to. A variety of information regarding a team's overall health, team cohesion, burnout of individuals/teams, psychological health of individuals/teams, promotion of a balanced team, encouraging different perspectives, encouraging shared understanding, suitable ways of working, continuous improvement, and/or the like may be able to be determined based on, at least in part, key words, team collaboration work graphs, and other user engagement data collected from the collaboration platforms.

The volume of potential information created during team engagement with collaboration platforms has continued to increase exponentially as more and more individuals and organizations expand their virtual collaboration. It is desirable to track engagement data collected for individuals, teams, organizations, and/or the like to produce team health metrics and to monitor overall team or user health. It is also desirable to identify and deliver technology based solutions for improving health metrics (e.g., team cohesion, burnout, and/or the like) for teams and individuals to increase productivity. Accordingly, the inventors have determined it would be desirable and advantageous to create a collaborative enterprise platform that is configured to programmatically monitor team and user engagement within internal collaboration platforms and/or external collaboration platforms to identify and programmatically trigger alerts, surveys, workflows, and other interventions at contextually appropriate times to improve team health.

Various embodiments of the present disclosure provide apparatuses, systems, computer-implemented methods, and computer program products for capturing collaborative work data in internal collaboration platforms and/or external collaboration platforms, determining team health metrics, and/or generating one or more team health metrics dashboards that are represented within a team assessment interface that is rendered to a client device. Such team assessment interface may be configured to display one or more team improvement intervention components that are configured to encourage user engagement and to improve team health metrics. In still further embodiments, collaborative work data may be captured to generate team health training datasets, which are used to train machine learning models that can be used to configure a contextually triggered team improvement engine as discussed in greater detail below.

### Definitions

As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

The term “computer-readable storage medium” refers to a non-transitory, physical, or tangible storage medium (e.g., volatile or non-volatile memory), which may be differentiated from a “computer-readable transmission medium,” which refers to an electromagnetic signal.

The term “client device: and similar terms refer to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like.

The term “collaborative enterprise platform” refers to a computing environment associated with one or more computing devices (e.g., client devices) and one or more applications or software platforms (e.g., internal collaboration platforms, external collaboration platforms), where the environment enables the discovery of team health metrics, team health insights, programmatic team health improvement interventions, and the generation of team assessment interfaces, team health dashboard interfaces, and other technical means configured for improving team health. In various embodiments, a collaborative enterprise platform includes a “contextually triggered team improvement engine” or, more simply, a “contextually triggered engine” that is configured with program logic and circuitry to execute the functionality attributed to the collaborative enterprise platform as discussed herein. The contextually triggered engine can be embodied by one or more software applications and/or one or more services executing in support of one or more software applications. The contextually triggered engine is “contextually triggered” in that it is configured to initiate certain tasks or actions (e.g., team improvement intervention components) based the context of a particular team's health as determined through monitoring of team member user engagement within the collaborative enterprise platform, one or more external collaboration platforms, and/or one or more internal collaboration platforms.

The term “external collaboration platform” refers to one or more software programs, applications, networks, or services that are configured to enable collaborative engagement and interaction by and between enterprise users to generate external collaborative work data. In some embodiments, communications between an external collaborative platform and an internal collaboration platform (defined below) takes place through a firewall and/or other network security protocols. The external collaboration platform operates on a compiled code base or repository that is separate and distinct from that which supports any internal collaboration platform.

The external collaboration platform supports one or more external applications that are executed on one or more client devices (e.g., team member or enterprise user client devices), and which are configured to generate data or otherwise provide desired functionality to enterprise users. In some embodiments, an external collaboration platform communicates with the collaborative enterprise platform, and vice versa, through one or more application program interfaces (APIs). For example, the collaborative enterprise platform might seek to retrieve selected external collaborative work data by subscribing to or calling an API of one or more external collaboration platforms.

In some embodiments, the collaborative enterprise platform might be configured to pass or receive tokens or other authentication credentials that are used to facilitate secure communication between the external collaboration platform and the collaborative enterprise platform in view of designated network security features or protocols (e.g., network firewall protocols). Example embodiments of external collaboration platforms include messaging platforms (e.g., Slack, Microsoft Teams, etc.), email and calendar platforms (e.g., Gmail, Google Calendar, Microsoft Outlook, etc.), customer relationship management platforms (e.g., Salesforce, etc.), customer service platforms (e.g., Zendesk, etc.), and enterprise employee survey platforms (e.g., SurveyMonkey, etc.).

The term “external collaborative work data” refers to a data structure, associated with a value in a computer-readable storage medium and/or a computer-readable transmission medium, that is generated based on user engagement with one or more external collaboration platforms and/or with external applications of the external collaboration platform. The external collaborative work data can take the structural form of a vector or other appropriate data structure for representing work output data generated by an external application or service of the external collaboration platform. Put simply, external collaborative work data is generated when enterprise users perform work using the external collaboration platform and/or external applications associated supported or hosted by the external collaboration platform.

The external collaborative work data may be stored via computer-readable storage medium (e.g., in an external work data repository associated with an external collaboration platform server or cloud instance). External collaborative work data includes text data, image data, file data, message data, log data, time stamp data, application metadata, and other work data objects. External collaborative work data also includes data or metadata that documents work interactions among enterprise users such as, for example, user identifier, team identifier, organization identifier, external application origin identifier, external application destination identifier, status data, and other data objects that might be used to understand work related interactions occurring among enterprise users and/or to develop a work graph of such work related interactions. In some embodiments, external collaborative work data may be aggregated, de-identified, and anonymized to protect the privacy of enterprise users.

The term “internal collaboration platform” refers to one or more software programs, applications, networks, or services that are configured to enable collaborative engagement and interaction by and between enterprise users to generate internal collaborative work data. In some embodiments, communications between an internal collaboration platform and an external collaboration platform take place through a firewall and/or other network security protocols. The internal collaboration platform operates on a compiled code base or repository that is separate and distinct from that which supports the external collaboration platform.

The internal collaboration platform supports one or more internal applications that are executed on enterprise user client devices, and which are configured to generate data or otherwise provide desired functionality to enterprise users. In other embodiments, various internal applications of the internal collaboration platform may be supported by common platform services or microservices within the collaborative enterprise platform. In another embodiment, common user credentials or a common user credential protocol may be used to manage user access and permissions for various internal applications of the internal collaboration platform and for the collaborative enterprise platform. Example embodiments of internal collaboration platforms include Jira Software™, Jira Service Management™, Jira Work Management™, Confluence™ Bitbucket™, Trello™, Statuspage™, Opsgenie™, Jira Align™, Atlas™, and Halp™.

The term “internal collaborative work data” refers to a data structure, associated with a value in a computer-readable storage medium and/or a computer-readable transmission medium, that is generated based on user engagement with an internal collaboration platform and/or with internal applications of the internal collaboration platform. The internal collaborative work data can take the structural form of a vector or other appropriate data structure for representing work output data generated by an internal application or service of an internal collaboration platform. Put simply, internal collaborative work data is generated when enterprise users perform work using one or more internal collaboration platforms and/or internal applications associated with such internal collaboration platform(s).

The internal collaborative work data may be stored via computer-readable storage medium (e.g., in an internal work data repository associated with a collaborative enterprise platform server or cloud instance). Internal collaborative work data includes text data, image data, file data, message data, log data, time stamp data, application metadata, and other work data objects. Internal collaborative work data also includes data or metadata that documents work interactions among enterprise users such as user identifier, team identifier, internal application origin identifier, internal application destination identifier, and other data objects that might be used to understand work related interactions among enterprise users and/or to develop a work graph of such work related interactions. In some embodiments, internal collaborative work data may be aggregated, de-identified, and anonymized to protect the privacy of enterprise users.

The term “team health training dataset” refers to team and/or work related data objects or data structures that fit predefined or desired parameters and can operate as a source of truth for training a machine learning model to make predictions or assessments concerning team health and to generate programmatically triggered interventions associated with improving team health. In some embodiments, a team health training dataset may be generated by performing sentiment analysis operations and/or collaboration graph identification operations on external collaborative work data and/or internal collaborative work data. In some embodiments, team health training datasets are collected passively by extracting collaboration data from external collaborative work data and/or internal collaborative work data. Team health training datasets may also be collected or supplemented actively based on contextually triggered surveys that are programmatically introduced to users through team work interfaces or team assessment interfaces as discussed in greater detail below.

In some embodiments, team health training datasets may be used to train a data classification learning model that is used to apply one or more data classification labels to one or more data objects of the team health training dataset. In still other embodiments, a collaboration work graph may be developed from user interactions and connections that are documented within the external collaborative work data and/or internal collaborative work data to support collaboration graph identification operations.

The term “machine learning model” refers to an algorithm or mathematical expression that is configured to make predictions or classifications once it has been trained one or more using training datasets. A machine learning model may include a natural language processing (NLP) model, a machine learning (ML) pipeline, a linear regression model, a logistic regression model, a decision tree, a supervised learning model, an unsupervised learning model, a reinforcement learning model, or the like. In some embodiments, a machine learning model can include one or more machine learning libraries, for example, scikit-learn for the Python programming language, the like, or combinations thereof.

The term “trained team health improvement machine learning model” refers to an example machine learning model that is configured, when applied by a contextually triggered engine, to make team health related predictions, classifications, and to initiate one or more team improvement intervention components. In some embodiments, the trained team health improvement machine learning model is trained using external collaborative work data and/or internal collaborative work data of a team health training dataset. In some embodiments, team survey data may be further used as a feedback loop to train the trained team health improvement machine learning model. Trained team health improvement machine learning models may be created for an enterprise or organization. In some embodiments, trained team health improvement machine learning models may be created for specific teams or specific projects.

The term “collaboration work graph” refers to a data structure configured to represent the connected sequence of operations or steps executed within one or more internal collaboration platforms and one or more external collaboration platforms by team member devices during the performance of work tasks or projects. For example, an example collaboration work graph may represent networks of connection, communications, data organization, data exchange, application and/or service dependencies, user role identification and associated relationships, and combinations thereof. In some embodiments, a graphical representation of the collaboration work graph can be, at least partially, rendered via a graphical user interface. The collaboration work graph can comprise one or more weighted graphs, multigraphs, isomorphic graphs, trees, the like, or combinations thereof. In some embodiments, the machine learning model may be configured to generate the collaboration work graph based on in part the team health training dataset.

The term “team survey data” refers to a data structure, associated with a value in a computer-readable storage medium and/or a computer-readable transmission medium, that is generated based on user engagement with a survey object, form, or template and/or with survey applications accessed by the collaborative enterprise platform. The team survey data can take the structural form of a vector or other appropriate data structure for representing a user response or set of responses to one or more surveys. Team survey data is associated with data or metadata that includes, without limitation, user identifier, team identifier, external collaboration platform identifier, internal collaboration platform identifier, survey source identifier, and combinations thereof.

The term “team improvement insight component” refers to a data object that represents a graphical interface element that is indicative of a team health status, trend, prediction, or the like. Team improvement insight components are generated by the contextually triggered team improvement engine based on its monitoring of user engagement with the collaborative enterprise platform. Team improvement insight components are output to one or more client devices for rendering to a team assessment interface. In some embodiments, a team improvement insight component may cause rendering of a visual emphasis element (e.g., coloring scheme, visual intensity, sizing scheme, and/or the like) within a team assessment interface that is configured to visually compare a selected team's health metrics with historical team health metrics and/or other team health metrics. In some embodiments, the team improvement insight component may further comprise a team improvement intervention component (defined below) that is configured to provide recommendations on how to improve a selected team health metric.

In still other embodiments, a team improvement insight component may support rendering of all or part of a “team health dashboard interface” comprising an improvement progress status displaying the current improvement status of the selected team health metric. In some further embodiments, the improvement progress status is configured to be displayed in one or more ways, such as alphanumerically and/or via a visual progress status indicator component to visually depict (e.g., horizontal status bar(s), vertical status bar(s), pie chart, line chart, radial column chart, donut chart, icons, bubble chart, etc.) the improvement progress status. Such examples are for purposes of illustration and not of limitation and other suitable variations of depicting the team health metric improvement completion percentage measurement(s) are also contemplated by this disclosure as will be apparent to one of ordinary skill in the art.

The term “team assessment interface” refers to a graphical user interface that is configured to enable users to view and engage with one or more team improvement insight components, one or more team health dashboard interfaces, and/or to otherwise review team health metrics. A team assessment interface is rendered to a client device display based on data and instructions provided by the contextually triggered team improvement engine. A team assessment interface may include graphs (e.g., bar, line, pie charts, etc.), metrics, thresholds, statistics, dashboards, or other interface elements that embody or visually represent aspects of team health or productivity. Team assessment interfaces may be facilitated by a dedicated software application running on the client device or through a web browser running on the client device. Other non-limiting examples of a team assessment interface may include a backlog view interface with planning a future team improvement intervention component, a board view interface associated with an ongoing or active team improvement intervention components, a deployments view interface associated with tracking of completed or deployed team improvement intervention components, and a road maps view interface associated with tracking team improvement intervention component and progress across multiple teams.

The term “team improvement intervention component” refers to a data object that represents a suggested action, task, message, communication, alert, or other intercession that is determined to be likely to improve team health. Team improvement intervention components are generated by the contextually triggered team improvement engine based on its monitoring of user engagement with the collaborative enterprise platform. Team improvement intervention components are transmitted from the contextually triggered team improvement engine to one or more client devices. In some embodiments, team improvement intervention components may be rendered to a team assessment interface. In some embodiments, team improvement intervention components may be rendered as push notifications or alert indicators displayed within a team work interface.

Team improvement intervention components may trigger tasks or actions in one or more external collaboration platforms and/or one or more internal collaboration platforms. In some embodiments, team improvement intervention components may include a “survey interface component” and/or a “team improvement workflow interface component” that may be rendered to a team work interface (defined below) of an external collaboration platform and/or an internal collaboration platform. The survey interface component is a graphic user interface element, alert, window, or modal that is configured to gather team survey data regarding team health metrics or parameters. The team improvement workflow interface component is a graphic user interface element, alert, window, or modal that is configured to initiate a workflow, game, exercise, task, or activity for one or more team member users that is deemed likely to improve one or more team health metrics or parameters.

The term “team health metrics” refers to a data structures, associated with values in a computer-readable storage medium and/or a computer-readable transmission medium, that are generated based on user engagement with a survey platform, one or more external collaboration platforms, and/or one or more internal collaboration platforms. Team health metrics may be generated based survey data, internal collaborative work data, external collaborative work data, and/or user interaction with one or more team improvement intervention components. In some embodiments, team health metrics may be rendered within team improvement insight components rendered to a team assessment interface. In some embodiments, team health metrics may be compared to one or more team health metric thresholds to inform determinations as to team health and/or when determining to trigger one or more team improvement intervention components. In some embodiments, team health metrics may be collected into team health dashboard metrics sets for populating a team health dashboard interface that is rendered to a team assessment interface.

The term “team health metrics threshold” refers to a data structure, associated with a value or values in a computer-readable storage medium and/or a computer-readable transmission medium, that defines a limit, boundary, range, or other trigger point for a particular team health metric or set of team health metrics. In one embodiment, team health metric thresholds are identified manually by team leaders, health care professionals, or other parties interested in team health. In some embodiments, team health metric thresholds are rule based, programmatically determined, or learned through application of one or more machine learning models.

In various embodiments, a contextually triggered team improvement engine is configured to programmatically compare selected team health metrics to corresponding team health metric thresholds. Such comparisons may be used to populate one or more team health dashboard interfaces or other team improvement insight components rendered to a team assessment interface. In other embodiments, team health metrics thresholds may be used by the contextually triggered team improvement engine to trigger one or more team improvement intervention components. For example, user engagement with a collaborative enterprise platform might indicate that a selected team health metric (e.g., team cohesion) has dropped below a corresponding team health metric threshold. This may cause the contextually triggered team improvement engine to trigger a team improvement intervention component appearing as a push notification in a team work interface of one or more team member client devices that causes respective team members to engage in a cohesion building game or other activity. In some embodiments, a team health metrics threshold may be the target value in which a selected team health metric needs to improve to achieve a desired team health status change or team health metric improvement.

The term “team health dashboard interface” refers to a graphical user interface or graphical user interface element that visually displays one or more team health metrics. In some embodiments, a team health dashboard interface is associated with a team improvement insight component, a user identifier, a team identifier, and/or the like. The team health dashboard interface may be further configured to display a plurality of factors that contribute to a team's overall health such as psychological safety, team cohesion, burnout, team membership changes, and/or the like. In some embodiments, a team health dashboard interface may be configured to compare overall team health and/or specific team health metrics for an individual team to whole organization/enterprise team health metrics and/or team health metrics of other selected teams.

The terms “team identifier” or “team ID” refer to one or more items of data by which a team comprising one or more team members may be uniquely identified by a collaborative enterprise platform. For example, a team identifier may comprise one or more of ASCII text, encryption keys, identification certificates, a pointer, an IP address, a URL, a MAC address, a memory address, or other unique identifier, or combinations.

The terms “team member identifier” or “team member ID” refer to one or more items of data by which a team member may be uniquely identified by a collaborative enterprise platform. For example, a team member identifier may comprise one or more of ASCII text, encryption keys, identification certificates, a pointer, an IP address, a URL, a MAC address, a memory address, or other unique identifier, or combinations.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in the at least one embodiment of the present invention and may be included in more than one embodiment of the present invention (importantly, such phrases do not necessarily refer to the same embodiment).

The terms “illustrative,” “example,” “exemplary” and the like are used herein to mean “serving as an example, instance, or illustration” with no indication of quality level. Any implementation described herein as “exemplary” is not necessarily to be construed as preferred or advantageous over other implementations.

The terms “about,” “approximately,” or the like, when used with a number, may mean that specific number, or alternatively, a range in proximity to the specific number, as understood by persons of skill in the art field.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The term “set” refers to a collection of one or more items.

The term “plurality” refers to two or more items.

The term “or” is used herein in both the alternative and conjunctive sense, unless otherwise indicated.

### Example System Architecture & Description of Certain Embodiments

Methods, apparatus, and computer program products of the present disclosure may be embodied by an of a variety of computing devices. For example, the method, apparatus, and computer program product of an example embodiment may be embodied by a networked device, such as a server or other network entity, configured to communicate with one or more devices, such as one or more client devices. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, or any combination of the aforementioned devices.

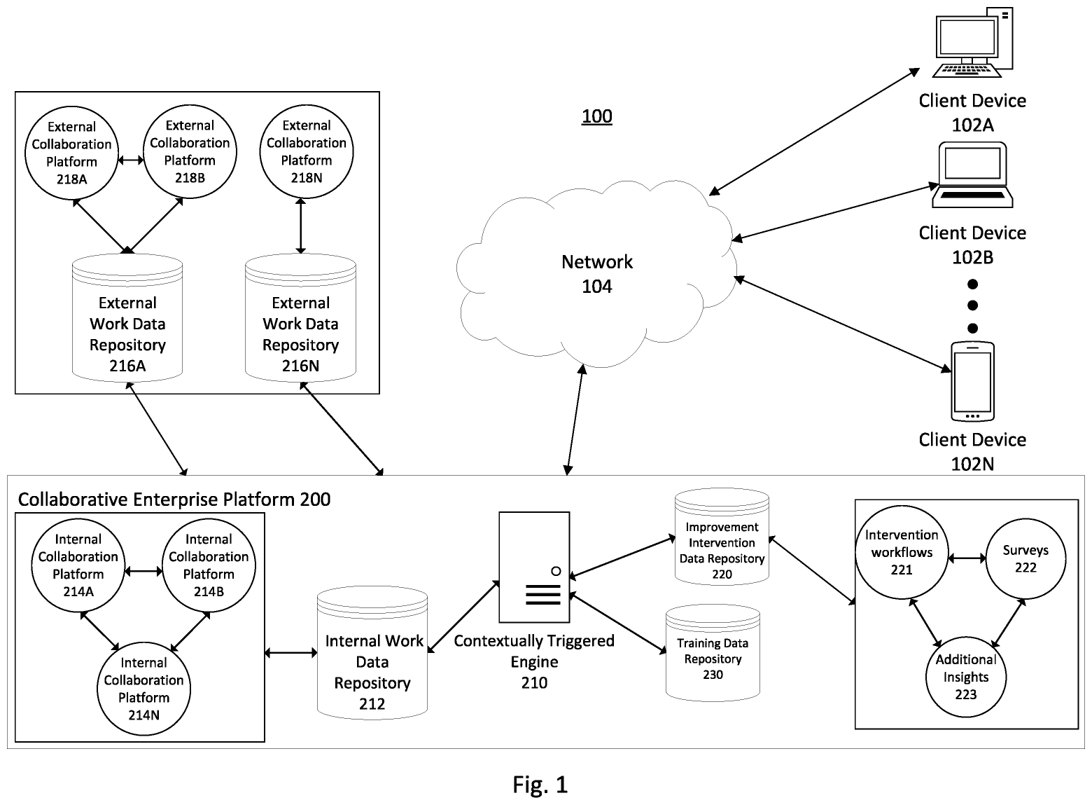

With reference to FIG. 1, an example computing system 100 within which some embodiments of the present disclosure operate is illustrated. User(s) may access a collaborative enterprise platform 200 via a communications network 104 using one or more of client devices 102A-102N. Collaborative enterprise platform 200 comprises a contextually triggered engine 210 in communication with at least one repository, such as an internal work data repository 212, a training data repository 230, and/or an improvement intervention data repository 220. Such repository(ies) may be hosted by the collaborative enterprise platform 200 or otherwise hosted by auxiliary devices in communication with the collaborative enterprise platform 200. For example, the depicted contextually triggered engine 210 is disposed in communication with one or more external work data repositories 216A-N hosted by one or more external collaboration platforms 218A-N.

Collaborative enterprise platform 200 may include circuitry, networked processors, or the like configured to perform some or all of the server-based processes described herein and may be any suitable network server, cloud computing machine, and/or other type of processing device. In some embodiments, collaborative enterprise platform 200 may determine and transmit commands and instructions for rendering one or more user interfaces (e.g., team assessment interfaces, etc.) to client devices 102A-102N, using data from, for example, improvement intervention data repository 220, internal work data repository 212, training data repository 230, and/or one or more external work data repository 216A-N.

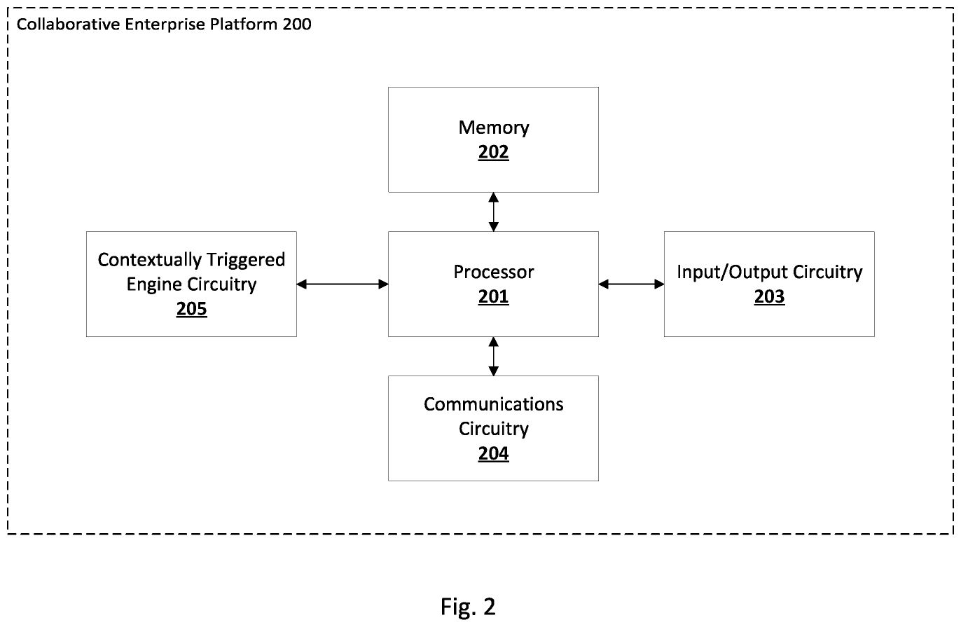

In this regard, the collaborative enterprise platform 200 may be embodied by any of a variety of devices, for example, the collaborative enterprise platform 200 may be embodied as a computer or a plurality of computers. For example, collaborative enterprise platform 200 may be configured to receive/transmit data and may include any of a variety of fixed terminals, such as a server or desktop computer, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith.

In some embodiments, collaborative enterprise platform 200 is located remotely from the improvement intervention data repository 220, internal work data repository 212, external work data repository 216 and/or training data repository 230. In one embodiment, an example collaborative enterprise platform 200 is hosted by a common cloud computing platform that is shared by the internal collaboration platforms 214A-N, the improvement intervention data repository 220, internal work data repository 212, one or more training data repositories 230, and/or one or more team intervention applications (e.g., intervention workflows 221, intervention surveys 222, additional intervention insight applications 223). The collaborative enterprise platform 200 may, in some embodiments, comprise several servers or computing devices performing interconnected and/or distributed functions. Despite the many arrangements contemplated herein, collaborative enterprise platform 200 is shown and described herein as a single computing device to avoid unnecessarily overcomplicating the disclosure.

Collaborative enterprise platform 200 can communicate with one or more client devices 102A-102N via communications network 104. Communications network 104 may include any one or more wired and/or wireless communication networks including, for example, a wired or wireless local area network (LAN), personal area network (PAN), metropolitan area network (MAN), wide area network (WAN), or the like, as well as any hardware, software and/or firmware required for implementing the one or more networks (e.g., network routers, switches, hubs, etc.). For example, communications network 104 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the communications network 104 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the collaborative enterprise platform 200.

Internal work data repository 212 may be stored by any suitable storage device configured to store some or all of the information described herein (e.g., memory 202 of the collaborative enterprise platform 200 or a separate memory system separate from collaborative enterprise platform 200, such as one or more database systems, backend data servers, network databases, cloud storage devices, or the like provided by another device (e.g., online application or 3rd party provider)), such as a Network Attached Storage (NAS) device or devices, or as a separate database server or servers. Internal work data repository 212 may comprise data received from the collaborative enterprise platform 200 (e.g., via a memory 202 and/or processor(s) 201), and the corresponding storage device may thus store this data. Internal work data repository 212 includes information accessed and stored by the collaborative enterprise platform 200 to facilitate the operations of the collaborative enterprise platform 200. In various embodiments, the one or more internal work data repositories 212 include internal collaborative work data generated based on user engagement with the one or more internal collaboration platforms 214A-N. As such, internal work data repository 212 may include, for example, without limitation, user identifiers, team member identifiers, team identifiers, project identifiers, internal collaboration platform identifiers, and other data or metadata that is necessary or useful for completing work within the context of one or more internal collaboration platforms.

The one or more external work data repositories 216A, 216N (collectively '216) may be stored by any suitable storage device configured to store some or all of the information described herein (e.g., memory of one or more external collaboration platform, such as one or more database systems, backend data servers, network databases, cloud storage devices, or the like provided by another device (e.g., online application or 3rd party provider)), such as a Network Attached Storage (NAS) device or devices, or as a separate database server or servers.

The one or more external work data repositories 216A-N include data generated by the one or more external collaboration platforms 218A-N, and the corresponding storage device may thus store this data. The one or more external work data repositories 216A-N includes information accessed and stored by the one or more external collaboration platforms 218A-N to facilitate operations of the one or more external collaboration platforms 218A-N. In various embodiments, the one or more external work data repositories 216A-N include external collaborative work data generated based on user engagement with the one or more external collaboration platforms 218A-N. As such, one or more external work data repositories 216 may include, for example, without limitation, user identifiers, team member identifiers, team identifiers, project identifiers, external collaboration platform identifiers, and other data or metadata that is necessary or useful for completing work within the context of one or more external collaboration platforms.

Improvement intervention data repository 220 may be any suitable storage device (e.g., memory 202 of the collaborative enterprise platform 200 or a separate memory system separate from collaborative enterprise platform 200, such as one or more database systems, backend data servers, network databases, cloud storage devices, or the like provided by another device (e.g., online application or 3rd party provider), such as a Network Attached Storage (NAS) device or devices) configured to store some or all of the data used or generated by the contextually triggered engine 210. Improvement intervention data repository 220 may comprise data received from the collaborative enterprise platform 200 (e.g., via a memory 202 and/or processor(s) 201), and the corresponding storage device may thus store this data. Improvement intervention data repository 220 includes information accessed and stored by the collaborative enterprise platform 200 to facilitate operations of the contextually triggered engine 210. For example, improvement intervention data repository may store collaboration work graphs, team org charts, team survey data, team improvement insight components, team health metrics sets, team health thresholds, team health dashboard metrics, and other similar information.

Improvement intervention data repository 220 further includes information accessed and stored by one or more intervention applications or services including, without limitation, an intervention workflows application 221, an intervention survey application 222, and an intervention additional insights application 223. As such, improvement intervention data repository 220 may include, for example, without limitation, team improvement intervention components, survey data, survey template data, user identifiers, team identifiers, project identifiers, workflow identifiers, team improvement insight identifiers, intervention messages, alert data, and/or other data or metadata that is necessary or useful for triggering and executing team improvement interventions within the context of one or more collaborative enterprise platform 200.

Training data repository 230 may be any suitable storage device (e.g., memory 202 of the collaborative enterprise platform 200 or a separate memory system separate from collaborative enterprise platform 200, such as one or more database systems, backend data servers, network databases, cloud storage devices, or the like provided by another device (e.g., online application or 3rd party provider), such as a Network Attached Storage (NAS) device or devices) configured to store one or more machine learning models, one or more team health training datasets, and one or more trained team health improvement machine learning models as described herein. Training data repository 230 may comprise data received from the collaborative enterprise platform 200 (e.g., via a memory 202 and/or processor(s) 201) and the corresponding storage device may thus store this data. Training data repository 230 includes information accessed and stored by the collaborative enterprise platform 200 to facilitate operations of the contextually triggered engine 210.

The client devices 102A-102N may be implemented as any computing device as defined above. Electronic data received by the collaborative enterprise platform 200 from the client devices 102A-102N may be provided in various forms and via various methods. For example, the client devices 102A-102N may include desktop computers, laptop computers, smartphones, netbooks, tablet computers, wearables, and/or other networked device, that may be used for any suitable purpose in addition to presenting the team assessment interface to a user and otherwise providing access to the collaborative enterprise platform 200. The depiction in FIG. 1 of “N” client devices is merely for illustration purposes.

According to some embodiments, the client devices 102A-102N may be configured to display an interface on a display of the client device for viewing, creating, editing, and/or otherwise interacting with at least one user interface, which may be provided by the collaborative enterprise platform 200. According to further embodiments, the client devices 102A-102N may be configured to generate and/or display a team heath metrics dashboard on a team assessment interface, team improvement intervention components on a team work interface, and/or the like.

In embodiments where a client device 102A-102N is a mobile device, such as a smartphone or tablet, the client device 102A-102N may execute an “app” to interact with the collaborative enterprise platform 200, one or more external collaboration platforms 218A-N, and/or one or more internal collaboration platforms 214A-N. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. The mobile operating systems named above each provide frameworks for interacting with, for example, wired and wireless network interfaces, user contacts, and other applications. Communication with hardware and software modules executing outside of the app is typically provided via application programming interfaces (APIs) provided by the mobile device operating system. Additionally, or alternatively, the client device 102A-102N may interact with the collaborative enterprise platform 200 via a web browser. As yet another example, the client devices 102A-102N may include various hardware or firmware designed to interface with the collaborative enterprise platform 200.

Multiple devices such as a tablet or a smart phone, for example, an app may be provided that executes on mobile device operating system, such as iOS, Android or Windows. These platforms typically provide frameworks that allow apps to communicate with one another and with particular hardware and software components for mobile devices. The mobile operating devices named above each provide frameworks for interacting with, for example, wired and wireless network interfaces, user contacts and other applications. Communication with hardware and software modules executing outside of the app is typically provided via application program interfaces (APIs) provided by the mobile device operating system. Additionally, or alternatively, the client devices, 102A-102N, may interact with the collaborative enterprise platform, 200, one or more external collaboration platforms 218A-N, and/or one or more internal collaboration platforms 214A-N, via a web browser.

As yet, another example, the client device is 102A-102N, may include various hardware or firmware designed to interface with the collaborative enterprise platform 200, one or more external collaboration platforms 218A-N, and/or one or more internal collaboration platforms 214A-N. With further reference to FIG. 1, the one or more internal work data repositories 212, may be configured to gather data from a plurality of internal collaboration platforms 214A-N, wherein the one or more internal collaboration platforms may support one or more internal collaboration applications that may be configured to execute on one or more client devices 102A-102N, and are configured to generate data or otherwise provide desired functionality to enterprise user. In various embodiments, the plurality of internal collaboration applications of the internal collaboration platforms may be supported by common platform services or microservices within a collaborative enterprise platform 200. In other embodiments, common user credentials or common user credential protocols may be used to manage user access and permissions for various internal collaboration applications of the internal collaboration platforms.

In various embodiments, the plurality of internal collaboration applications may connect, for example, via at least a communications network 104 or internal computing device pathway (e.g., APIs, etc.). It should be appreciated that each of the plurality of internal collaboration platforms 214A-N, may be configured to communicate with each other in accordance with a default configuration.

In various embodiments, the one or more internal work data repositories 212, may be configured to communicate with a contextually triggered engine 210 such as, for example, by enabling access of internal work collaborative data by the contextually triggered engine 210. The one or more internal work data repository 212 is configured to receive and store internal collaborative work data generated by one or more internal collaboration platforms 214A-N. Such internal collaborative work data may be accessed and used by the contextually triggered engine 210 to assist in creating a team health training data set for training a machine learning model as discussed in greater detail below.

In various embodiments, the internal collaborative work data is generated by user engagement with one or more internal collaboration platforms 214A-N via one or more client devices 102A-102N. The generated internal collaborative work data may include text data, file data, sentiment data, team data, collaborative user interaction data, project data, communication data, and other work data objects. The internal collaborative work data may include data or metadata that documents work interactions among one or more users. The internal collaborative work data may further comprise data such as user identifier, team identifier, internal application origin identifier, internal application destination identifier, and/or other data objects that might be used to understand and/or to graph work related interactions occurring among one or more team members or other users. In various embodiments, the internal collaborative work data may be further utilized to generate one or more team improvement intervention components configured to be rendered to a team assessment interface displayed on one or more client devices 102A-102N.

A collaborative enterprise platform 200, may be further configured to communicate with one or more external work data repositories 216A-216N of one or more corresponding external collaboration platforms 218A-N. In such embodiments, the one or more external collaboration platforms 218A-N may be configured to enable collaborative engagement and interaction between team members using one or more client devices 102A-102N to generate external collaborative work data. Such external collaborative work data is stored to the depicted external work data repositories 216A-N.

In various embodiments, the collaborative enterprise platform 200 is configured to communicate with one or more external collaboration platforms 218A-N and one or more internal collaboration platforms 214A-N simultaneously. Notably, communication occurring between the collaborative enterprise platform 200 and the one or more external collaboration platforms 218A-N occurs through one or more security layers or security protocols (e.g., firewalls, encrypted communication protocols, secure APIs, etc.) that are not used for communication occurring between the collaborative enterprise platform 200 and the one or more internal collaboration platforms 214A-N. For example, one or more external collaboration platforms 218 may generate one or more tokens or other authentication credentials that are used to facilitate secure communication with the collaborative enterprise platform 200.

In various embodiments, the external work data may include text data, file data, sentiment data, collaborative user interaction data, project data, communication data, team data, and other work data objects. In further embodiments, the external collaborative work data may also include data or meta data that documents work interactions among enterprise users such as user identifiers, team identifiers, external application origin identifiers, external application destination identifiers and or other data objects that might be used to understand work related interactions occurring among one or more team member users.

FIG. 2 shows a schematic block diagram of an example circuitry, some or all of which may be included in collaborative enterprise platform 200. In accordance with some example embodiments, circuitry may include various means, such as processor 201, memory 202. input/output circuitry 203, and/or communications circuitry 204. In some embodiments, such as when circuitry is included in a collaborative enterprise platform 200, contextually triggered engine circuitry 205 may also be included.

The depicted contextually triggered engine circuitry 205 is configured to process internal collaborative work data, external collaborative work data, survey data, collaboration work graphs, and other associated team, user, and/or enterprise information to generate team health metrics, team health metric thresholds, team health training datasets, trained team health improvement machine learning models, team improvement insight components, and team improvement intervention components. The contextually triggered engine circuitry is further configured to generate one or more team health metrics dashboard interfaces, and/or one or more team assessment interfaces.

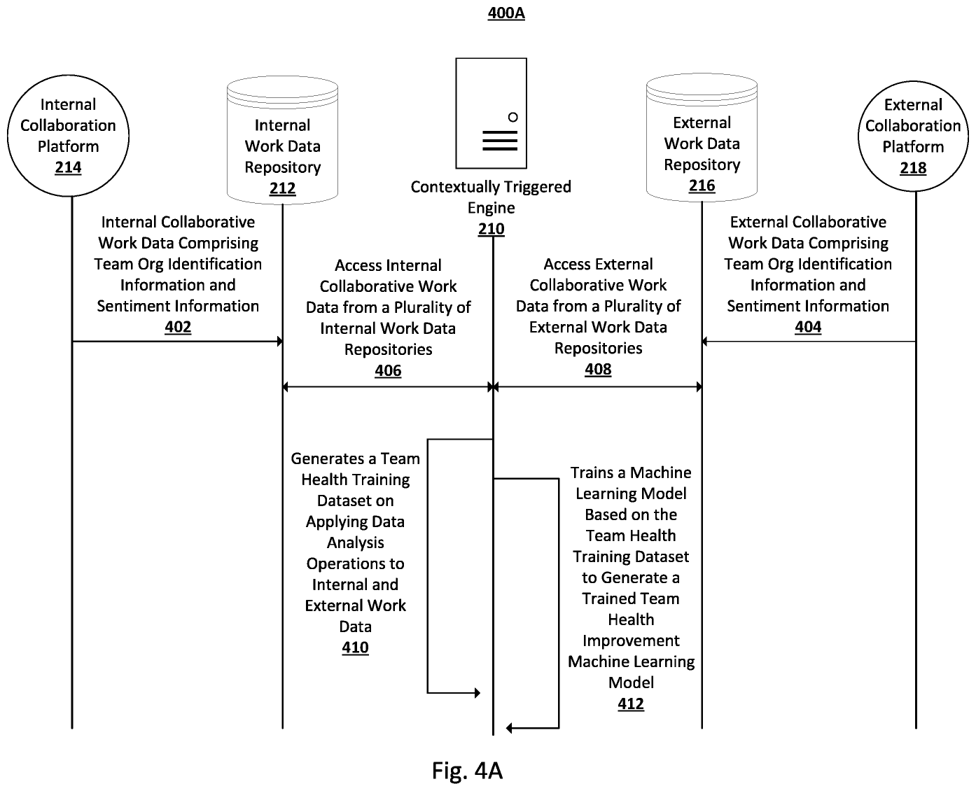

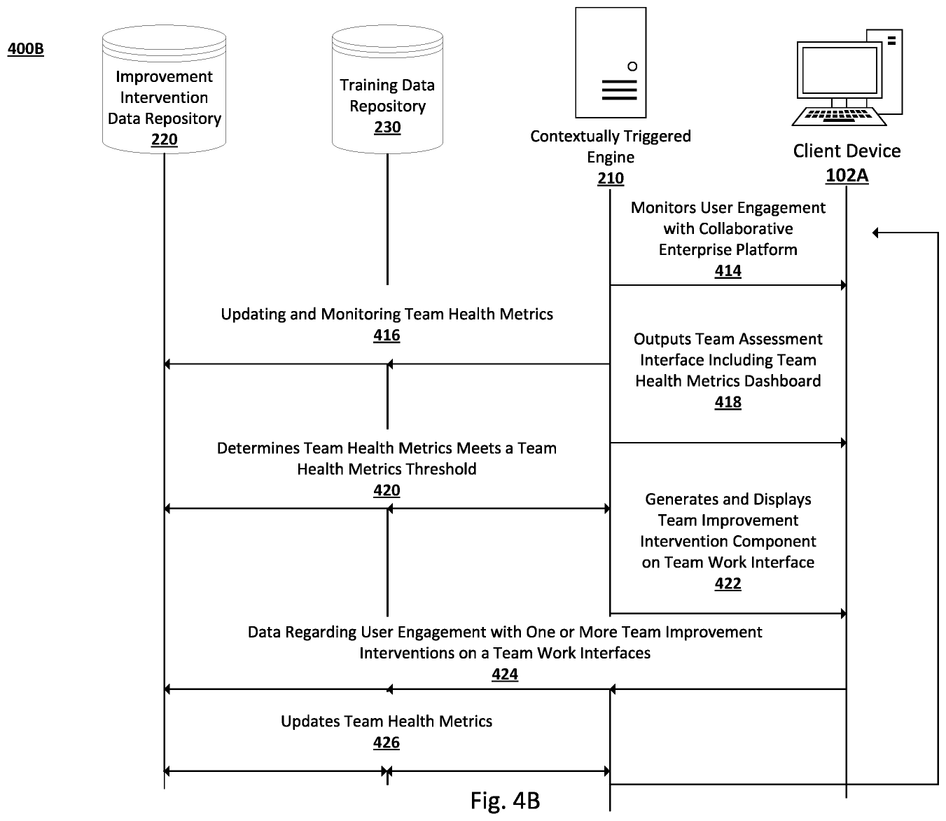

An apparatus, such as collaborative enterprise platform 200 or client device(s) 102A-102N, may be configured, using one or more of the circuitry 201, 202, 203, 204, and 205, to execute the operations described above with respect to FIG. 1 and below in connection with FIGS. 4A-9B. Although these components (e.g., processor 201, memory 202, etc.) are described with respect to functional limitations, it should be understood that the particular implementations necessarily include the use of particular hardware, software, and/or firmware. It should also be understood that certain of these components (e.g., processor 201, memory 202, etc.) may include similar or common hardware. For example, multiple sets of circuitry may both leverage use of the same processor, network interface, storage medium, or the like to perform their associated functions, such that duplicate hardware is not required for each set of circuitry.

The term “circuitry” should also be understood, in some embodiments, to include software for configuring the hardware. For example, in some embodiments, “circuitry” may include processing circuitry, storage media, network interfaces, input/output devices, and the like. In some embodiments, such as in examples where circuitry is included with collaborative enterprise platform 200, other elements of the collaborative enterprise platform 200 may provide or supplement the functionality of particular circuitry. For example, the processor 201 may provide processing functionality, the memory 202 may provide storage functionality, the communications circuitry 204 may provide network interface functionality, and the like.

In some embodiments, the processor 201 (and/or co-processor or any other processing circuitry assisting or otherwise associated with the processor) may be in communication with the memory 202 via a bus for passing information among components of, for example, collaborative enterprise platform 200. The memory 202 is non-transitory and may include, for example, one or more volatile and/or non-volatile memories, or some combination thereof. In other words, for example, the memory 202 may be an electronic storage device (e.g., a computer readable storage medium). The memory 202 may be configured to store information, data, content, applications, instructions, or the like, for enabling an apparatus, e.g., collaborative enterprise platform 200 to carry out various functions in accordance with example embodiments of the present disclosure.

Although illustrated in FIG. 2 as a single memory, memory 202 may comprise a plurality of memory components. The plurality of memory components may be embodied on a single computing device or distributed across a plurality of computing devices. In various embodiments, memory 202 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 202 may be configured to store information, data, applications, instructions, or the like for enabling circuitry to carry out various functions in accordance with example embodiments discussed herein. For example, in at least some embodiments, memory 202 is configured to buffer data for processing by processor 201. Additionally or alternatively, in at least some embodiments, memory 202 is configured to store program instructions for execution by processor 201. Memory 202 may store information in the form of static and/or dynamic information. This stored information may be stored and/or used by circuitry during the course of performing its functionalities.

Processor 201 may be embodied in a number of different ways and may, for example, include one or more processing devices configured to perform independently. Additionally or alternatively, processor 201 may include one or more processors configured in tandem via a bus to enable independent execution of instructions, pipelining, and/or multithreading. Processor 201 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, processor 201 comprises a plurality of processors. The plurality of processors may be embodied on a single computing device or may be distributed across a plurality of such devices collectively configured to function as circuitry (e.g., collaborative enterprise platform 200). The plurality of processors may be in operative communication with each other and may be collectively configured to perform one or more functionalities of circuitry as described herein.

In an example embodiment, processor 201 is configured to execute instructions stored in the memory 202 or otherwise accessible to processor 201. Alternatively or additionally, the processor 201 may be configured to execute hard-coded functionality. As such, whether configured by hardware or software methods, or by a combination thereof, the processor 201 may represent an entity (e.g., physically embodied in circuitry) capable of performing operations according to an embodiment of the present disclosure while configured accordingly. Alternatively, as another example, when the processor 201 is embodied as an executor of software instructions, the instructions may specifically configure processor 201 to perform one or more algorithms and/or operations described herein when the instructions are executed. For example, these instructions, when executed by processor 201, may cause collaborative enterprise platform 200 to perform one or more of the functionalities of collaborative enterprise platform 200 as described herein.

In some embodiments, input/output circuitry 203 may, in turn, be in communication with processor 201 to provide an audible, visual, mechanical, or other output and/or, in some embodiments, to receive an indication of an input. In that sense, input/output circuitry 203 may include means for performing analog-to-digital and/or digital-to-analog data conversions. Input/output circuitry 203 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. Input/output circuitry 203 may comprise a user interface (e.g., a team work user interface, an team improvement intervention component, a team health metrics dashboard, etc.) and may comprise a web user interface, a mobile application, or the like. The processor 201 and/or user interface circuitry comprising the processor 201 may be configured to control one or more functions of a display or one or more user interface elements through computer program instructions (e.g., software and/or firmware) stored on a memory accessible to the processor 201 (e.g., memory 202, and/or the like). In embodiments where circuitry may be implemented as a contextually triggered engine 210, as shown in FIG. 2, aspects of input/output circuitry 203 may be reduced as compared to embodiments where circuitry may be implemented as an end-user machine or other type of device designed for complex user interactions (i.e., client device 102). In some embodiments (like other components discussed herein), input/output circuitry 203 may even be eliminated from circuitry. Alternatively, such as in embodiments wherein circuitry is embodied as collaborative enterprise platform 200, at least some aspects of input/output circuitry 203 may be embodied on an apparatus used by a team member user that is in communication with circuitry. Input/output circuitry 203 may be in communication with memory 202, communications circuitry 204, and/or any other component(s), such as via a bus. Although more than one input/output circuitry and/or other component can be included in circuitry, only one is shown in FIG. 2 to avoid overcomplicating the disclosure (e.g., like the other components discussed herein).

Communications circuitry 204 may be any means such as a device or circuitry embodied in either hardware or a combination of hardware and software that is configured to receive and/or transmit data from/to a network and/or any other device, circuitry, or module in communication with circuitry, e.g., collaborative enterprise platform 200. In this regard, the communications circuitry 204 may include, for example, a network interface for enabling communications with a wired or wireless communication network. Communications circuitry 204 may be configured to receive and/or transmit any data that may be stored by memory 202 using any protocol that may be used for communications between computing devices. For example, the communications circuitry 204 may include one or more network interface cards, antennae, transmitters, receivers, buses, switches, routers, modems, and supporting hardware and/or software, and/or firmware/software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by the circuitry using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. Communications circuitry 204 may additionally or alternatively be in communication with the memory 202, input/output circuitry 203 and/or any other component of circuitry, such as via a bus.

In some embodiments, contextually triggered engine circuitry 205 may also or instead be included and configured to perform the functionality discussed herein related to providing a team assessment interface, one or more team improvement insight components, and/or one or more team improvement intervention components. Contextually triggered engine circuitry 205 includes hardware components and/or software configured to support contextually triggered engine-related functionality, features, and/or services of the circuitry (e.g., collaborative enterprise platform 200, client device 102A). In some embodiments, contextually triggered engine circuitry 205 includes hardware components and/or software configured to support a machine learning model to provide development unit insight-related functionality, features, and/or services of the circuitry (e.g., collaborative enterprise platform 200, client device 102A). The contextually triggered engine circuitry 205 may utilize processing circuitry, such as the processor 201, to perform its corresponding operations, and may utilize memory 202 to store collected information. The contextually triggered engine circuitry 205 may send and/or receive data from internal work data repository 212, external work data repository 216, and/or improvement intervention data repository 220.

In some implementations, the sent and/or received data may include identifier(s) (e.g., user identifier, team identifier, team member identifier, development unit identifier, project identifier, customer identifier, and/or the like). It should also be appreciated that, in some embodiments, the contextually triggered engine circuitry 205 may include a separate processor, specially configured field programmable gate array (FPGA), or application specific interface circuit (ASIC) to perform its corresponding functions. For example, in some embodiments, some or all of the functionality of contextually triggered engine circuitry 205 may be performed by processor 201. In this regard, some or all of the example processes and algorithms discussed herein can be performed by at least one processor 201 and/or contextually triggered engine circuitry 205. For example, non-transitory computer readable storage media can be configured to store firmware, one or more application programs, and/or other software, which include instructions and other computer-readable program code portions that can be executed to control processors of the components of collaborative enterprise platform 200 by circuitry to implement various operations, including the examples shown herein. As such, a series of computer-readable program code portions may be embodied in one or more computer program products and can be used, with a device, collaborative enterprise platform 200, database, and/or other programmable apparatus, to produce the machine-implemented processes discussed herein. It is also noted that all or some of the information discussed herein can be based on data that is received, generated and/or maintained by one or more components of the circuitry (e.g., collaborative enterprise platform 200, client device 102A, etc.). In some embodiments, one or more external systems (such as a remote cloud computing and/or data storage system) may also be leveraged to provide at least some of the functionality discussed herein.

As described above and as will be appreciated based on this disclosure, embodiments of the present disclosure may be configured as systems, methods, apparatuses, computing devices, personal computers, servers, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions embodied in the computer-readable storage medium (e.g., computer software stored on a hardware device). Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor or other programmable apparatus's circuitry to produce a machine, such that the computer, processor, or other programmable circuitry that execute the code on the machine creates the means for implementing various functions, including those described herein in connection with the components of circuitry.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a planning user interacting with the client device). Information/data generated at the client device (e.g., a result of the user interaction) can be received from the client device at the server.

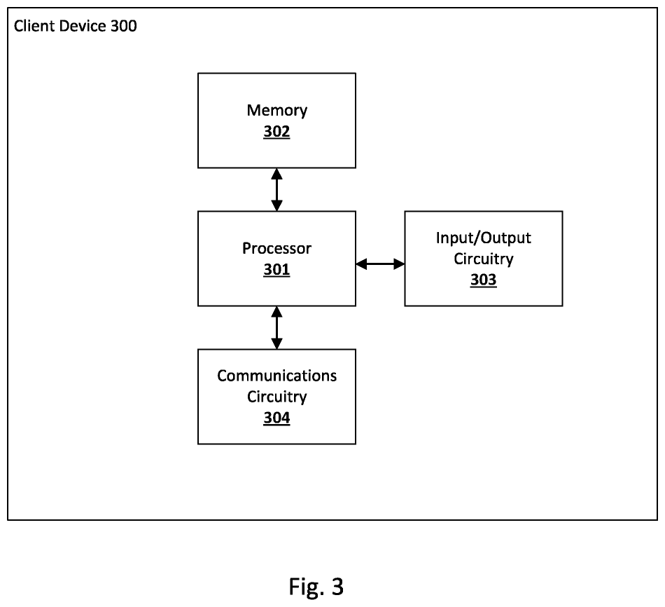

FIG. 3 shows a schematic block diagram of an exemplary circuitry. Some or all of which may be included in a client device 300, in accordance with some example embodiments circuitry may include various means such as processor 301, memory 302, input/output circuitry 303, and/or communications circuitry 304.

In some embodiments, the processor 301 (and/or coprocessor or any other processing circuitry assisting or otherwise associated with the processor) may be in communication with the memory 302 via a bus for passing information among components of, for example, a client device 300. The memory 302 is non transitory and may include, for example, one or more volatile and/or non-volatile memories or some combination thereof. In other words, for example, the memory 302, may be a storage device (e.g., a computer readable storage medium). The memory 302 may be configured to store information, data, content application instruction and/or the like for enabling an apparatus (e.g., client device 300) to carry out various functions in accordance with example embodiments of the present disclosure. Although illustrated in FIG. 3 as a single memory, memory 302 may comprise a plurality of memory components. The plurality of memory components may be embodied on a single computing device or distributed across a plurality of client devices. In various embodiments, memory 302 may comprise, for example, a hard disk, random access memory, cache memory, flash memory, a compact disk, read only memory (CD-ROM), digital versatile disk read only memory (DVD-ROM), an optical disk, circuitry configured to store information, or some combination thereof.

Memory 302 may be configured to store information, data, application instructions and/or the like for enabling circuitry to carry out various function in accordance with example embodiments discussed herein. In an example embodiment, processor 301 is configured to execute instructions stored in the memory 302 or otherwise accessible to the processor 301. Alternatively or additionally, the processor 301 may be configured to execute hard coded functionalities. As such, whether configured by hardware or software methods or by a combination thereof, the processor 301, may represent an entity (e.g., physically embodied in circuitry) capable of performing operations according to an embodiment of the present disclosure. Alternatively, as in another example, when the processor 301 is embodied as an executor of software instructions, the instructions may specifically configure processor 301 to perform one or more algorithms and/or operations described herein when the instructions are executed. For example, these instructions when executed by processor 301 may cause client device 300 to perform one or more functionalities of a client device 102 as described herein. In some embodiments, input/output circuitry 303 may in turn be in communication with processor 301 to provide an audible, visual, mechanical or other output and/or in some embodiments to receive an indication of input.

Input/output circuitry 303 may include means for performing analog to digital and/or digital to analog data conversion. Input/output circuitry 303 may include support, for example, for a display, touch screen, keyboard, button, click wheel, mouse, joystick, an image capturing device (e.g., a camera), motion sensor (e.g., accelerometer and/or gyroscope), microphone, audio recorder, speaker, biometric scanner and/or other input/output mechanisms. Input/output circuitry 303 may comprise a user interface (e.g., a team work interface, a team assessment interface, a team health metrics dashboard interface, etc.) and may comprise a web-user interface, a mobile application, and/or the like. The processor 301 and/or other interface circuitry comprising the processor 301 may be configured to control one or more functions of a display or one or more user interface elements through computer program instruction (e.g., software and/or firmware) stored on a memory accessible to the processor 301(e.g., memory 302, and/or the like.

Communications circuitry 304 may be any means such as a device or circuitry embodied in either hardware or a combination of hardware and software that is configured to receive and/or transmit data from/to a network and/or any other device, circuitry or module in communication with circuitry (e.g., client device 300). In this regard, the communications circuitry 304 may include, for example, a network interface for enabling communication with a wired or wireless communication network. Communications circuitry 304 may be configured to receive and/or transmit any data that may be stored by memory 302 using protocols that may be used for communication between computing devices. For example, the communications circuitry 304 may include one or more network interface cards, antenna, transmitter, receiver, buses, switches, routers, modems and supporting hardware and/or software, and/or firmware/software, or any other device suitable for enabling communications via network. Additionally or alternatively, the communication interface may include the circuitry for interacting with the antenna to cause transmission of signal via the antenna or to handle receipt of signals received via the antenna. These signals may be transmitted by circuitry using any of a number of wireless, personal area networks (PAN) technology, such as Bluetooth V 1.0 though V 3.0, Bluetooth low energy (BLE), inferred wireless (e.g., IRDA), ultra-wide band (UWB), induction wireless transmission, and/or the like. In addition, it should be understood that these signals may be transmitted using Wi-Fi, Near Field communications (NFC), world-wide interoperability for microwave access (WiMAX), and/or other proximity-based communications protocols. Communications circuitry 304 may additionally or alternatively be in communication with the memory 302, input/output circuitry 303 and or any other component of the circuitry via a bus.

FIGS. 4A-4B is a flow-chart illustrating a series of operations and/or process blocks that are executed or performed by elements of a collaborative enterprise platform to generate a team health training dataset, generate a trained team health improvement machine learning model based on the team health training dataset, generate team improvement insight components and associated team assessment and team health dashboard interfaces, generate one or more team improvement intervention components, and update the team health training dataset for retraining the trained team health improvement machine learning model.

In the embodiment illustrated in FIG. 4A, the flow-chart illustrates method 400A which includes contextually triggered engine 210 communicating with internal work data repository 212 and external work data repository 216 to access internal collaborative work data and external collaborative work data respectively at blocks 406 and 408. Internal collaborative work data and external collaborative work data are stored to the internal work data repository 212 and external work data repository 216 in real time at blocks 402 and 404.

In some embodiments, the contextually triggered engine 210 may be configured to store the internal collaborative work data and/or the external collaborative work data collected from the respective repositories 212, 216 to one or more storage memory 202 of a collaborative enterprise platform 200. In various embodiments, the contextually triggered engine 210, as depicted at block 410, may be configured to generate a team health training dataset from monitoring the internal collaborative work data and/or the external collaborative work data. In some embodiments, the contextually triggered engine 210 may be configured, using one or more machine learning models, to identify users as members of a team (e.g., allocate user identifiers to one or more team identifiers) based on data analysis of the internal collaborative work data and/or the external collaborative work data. This can be particular useful with modern enterprise teams that tend to change and mature with project, project stage, or sprint.

In one embodiment, a team health training dataset is generated by applying sentiment analysis, collaboration graph identification operations, and/or any other data analysis operations to the collected internal collaborative work data and/or the external collaborative work data. In another embodiment, team survey data may be used define the team health training dataset. In still other embodiments, the team health training data set may be identified through a feature extraction process, a rule-based process, or by application of a machine learning or clustering algorithm.

As illustrated at block 412, in some embodiments, method 400A may further include the contextually triggered engine 210 operating to train a machine learning model using the generated team health training dataset. In some embodiments, the contextually triggered engine 210 may be configured to generate a trained team health improvement machine learning model using the team health training dataset generated by the internal collaborative work-data and/or the external collaborative work-data.

FIG. 4B depicts an example signal diagram of exemplary data flow represented by method 400B. That is, FIG. 4B illustrates an example signal diagram illustrating data flow interactions between a contextually triggered engine 210, one or more client devices 102A, one or more training data repositories 230, and/or one or more improvement intervention data repositories 220.

As illustrated at block 414, in some embodiments, the contextually triggered engine 210 may be configured to monitor user engagement with the collaborative enterprise platform 200 (and additionally or alternatively one or more internal collaboration platforms and/or one or more external collaboration platforms) when using one or more client devices 102A. In various embodiment, the contextually triggered engine 210 may be configured to monitor user engagement with the collaborative enterprise platform 200 over a defined period of time. The contextually triggered engine 210 may be configured to monitor team user data, team survey data, team member engagement data, and/or the like associated with the collaborative enterprise platform 200.

As illustrated at block 416, the contextually triggered engine 210 may be configured to update data regarding collaborative work data and/or update team health metrics data, based at least in part on the collaborative work data captured during the monitoring occurring at block 414. In one embodiment, the contextually triggered engine is configured to generate a team assessment interface, at block 418, based on the collaborative work data and/or updated team health metrics data of block 416. In various embodiments, the team assessment interface comprises one or more team improvement insight components and is outputted to one or more client devices. In some embodiments, as reference herein, the team assessment interface may be configured to include one or more team health metrics dashboards.

In various embodiments, the contextually triggered engine 210 is configured to generate team improvement insight components that are based on engagement data of a particular team. In other embodiments, the contextually triggered engine 210 is configured to generate team improvement insight components that are based on engagement data of a particular project, issue, incident, organization, enterprise, and/or the like.

As illustrated at block 420, in some embodiments, the contextually triggered engine 210 may be configured to monitor team health metrics over a defined period of time and to determine if one or more team health metrics change in a manner that satisfies one or more team health metric thresholds. As will be apparent to one of ordinary skill in the art, team health metrics may vary widely between enterprises and teams. Thus, the contextually triggered engine 210 is configured to develop a baseline of one or more team health metrics and to monitor how such team health metrics change over time.

In some embodiments, the contextually triggered engine 210 is configured to transmit and/or store the generated collaborative work data to one or more improvement intervention data repositories 220 at defined times. In this way, the contextually triggered engine 210 is able to track and/or monitor any change of one or more team health metrics over time. For example, the contextually triggered engine 210 is configured to identify if one or more team health metrics have changed or deteriorated suggesting that certain team health metrics threshold have similarly deteriorated. Given that team health metrics are likely to vary widely depending on the enterprise, team, project, etc., it is important that the contextually triggered engine be configured to monitor changing team improvement insight components in this way.

In various embodiments, as illustrated at block 422, the contextually triggered engine 210 may be configured to generate and/or output one or more team improvement intervention components to a team work interface rendered to one or more client devices 102A in response to the team health metrics satisfying one or more team health metrics thresholds. In various embodiments, the client device 102A may be configured to display the one or more team improvement intervention components on a team work interface on one or more client devices 102A, wherein a user may engage with the team improvement intervention component in an efficient manner. In various embodiments, the contextually triggered engine 210 may be configured to generate and/or output one or more team improvement intervention components to a team health metrics dashboard rendered to one or more client devices 102A in response to the team health metrics satisfying one or more team health metrics threshold. In various embodiments, the client device 102A may be configured to display the one or more team improvement intervention components on a team health metrics dashboard on one or more client devices 102A, wherein a user may engage with the team improvement intervention component in an efficient manner.

In various embodiments, the one or more team improvement intervention components may be in the form of intervention surveys, intervention videos, coaching sessions, intervention lessons, and/or the like. In one or more embodiments, the team work interface may be configured to allow a user to choose from a plurality of team improvement intervention components (e.g., choose from a survey and/or a video coaching session). The one or more users may engage with the one or more team improvement intervention components on the team work interface generating team improvement data that may be stored on one or more improvement intervention data repositories 220 and/or one or more training data repositories 230.

In various embodiments, the contextually triggered engine 210 is configured to collect data associated with user engagement with the one or more team improvement intervention components and transmit such collected data to the training data repository 230 and the improvement intervention repository 220 at block 424. In various embodiments, the improvement intervention data repository 220 and/or the training data repository 230 may be configured to store the collected data regarding user engagement with one or more team improvement intervention components on a storage media (e.g., memory 202) of the collaborative enterprise platform 200.

In some embodiments, the collected data generated by user engagement with the one or more team improvement intervention components may be used to update the team health training dataset and eventually to update the trained machine learning model. User engagement data with the collaborative enterprise platform and associated team metrics data that is collected following user engagement with the one or more team improvement intervention components may be used to update the team health training dataset as a means for capturing the effect of the one or more team improvement intervention components.

As illustrated at block 426, in some embodiments, the one or more improvement intervention data repository 220 may be used or accessed by the contextually triggered engine 210 when updating one or more team health metrics (e.g., overall health, psychological safety, team cohesion, burnout, and/or the like). In some embodiments, the contextually triggered engine 210 may be configured to generate one or more additional team assessment interfaces comprising such updated team health metrics. In still other embodiments, the contextually triggered engine 210 may be configured to compare the updated team health metrics to one or more team health metrics thresholds and to suggest one or more additional team improvement intervention components may be needed based, at least in part, on the comparison of the updated team health metrics with the one or more team health metrics thresholds.

The contextually triggered engine 210 may be further configured to update the team health training data set of the training data repository 230. In various embodiments, the contextually triggered engine 210 may update the team health training dataset based on, at least in part, the one or more user interaction with one or more team improvement intervention components and/or the comparison of the updated team metrics with one or more team metric thresholds. In some embodiments, the updated team training dataset may be further utilized to iteratively train a machine learning model to create one or more updated trained team health improvement machine learning models. In various embodiments, the contextually triggered engine 210 may be configured to repeat the steps described in the flow diagram 400B continuously.

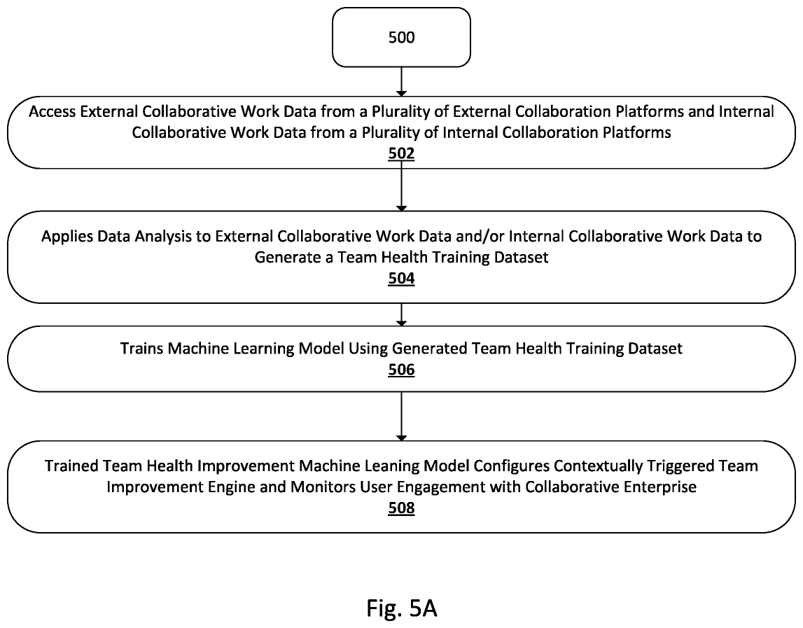

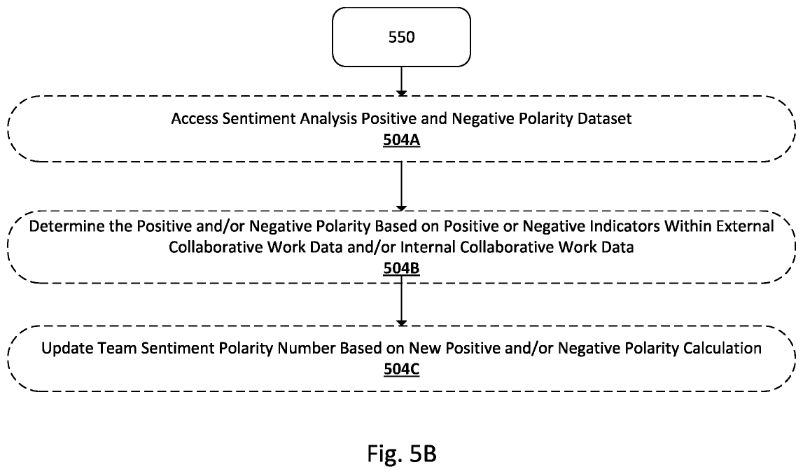

Example data analysis operations, such as those suggested in block 410 of FIG. 4A, are depicted in the operations of FIG. 5A. The depicted data analysis operations are performed by a collaborative enterprise platform 200 which may include means, such as a processor 201, input/output circuitry 203, memory 202 and/or communications circuitry 204 and/or contextually triggered engine circuitry 205, or the like, for applying operations to external collaborative work data and/or internal collaborative work data. The depicted data analysis operations may include, for example, sentiment analysis and collaboration graph identification operations that are applied to internal collaborative work data and external collaborative work data.

As illustrated in block 502 of method 500, the contextually triggered engine 210 may be configured to access external collaborative work data from one or more external collaborative work data repositories and access internal collaborative work data from one or more internal work data repositories. At block 504, in various embodiments, the contextually triggered engine 210 applies data analysis operations to the internal collaborative work data and the external collaborative work data. In some other embodiments, the contextually triggered engine 210 may be configured to apply data analysis in the form of sentiment analysis and/or collaboration graph identification operations to the internal collaborative work data and/or the external collaborative work data. In some further embodiments, the contextually triggered engine 210 may be further configured to apply sentiment analysis operation, collaboration graph identification operation, natural language processing, analysis of interactive patterns, analysis of response patterns, feature extraction processes, data aggregation operations, data normalization operations, and/or any other data analysis operations that may be needed to prepare the identified external collaborative work data and internal collaborative work data for inclusion in a team health training dataset.

As depicted in block 506, in various embodiments, the contextually triggered engine 210 is configured to use the generated team health training dataset to train a machine learning model. The machine learning model may be trained based on an NLP training process, a linear regression process, a logistic regression process, decision tree training, a supervised learning process, an unsupervised learning process, a reinforcement learning process, or the like.

As depicted in block 508, in various embodiments, the trained machine learning model is applied to configure the contextually triggered improvement engine to monitor user engagement with the collaborative enterprise platform 200. In various embodiments, the trained team health improvement machine learning model may configure the contextually triggered engine 210 to monitor and/or gather additional internal collaborative work data and/or additional external collaborative work data. The contextually triggered engine 210 may be configured to store such additional data to the corresponding work data repository.

In some embodiments, the contextually triggered engine 210 may be further configured to use the additional collected data to perform additional sentiment analysis and/or additional collaboration graph identification operations to assist in updating the team health training dataset and/or assist in updating the trained team health improvement machine learning model. In some embodiments, the updated team health training dataset may be applied to the already trained team health improvement machine learning model to update the trained team health improvement machine learning model to correspond with the additionally collected data.

Example operations for data analysis of internal collaborative work data and/or external collaborative work data, such as those suggested by block 504, are illustrated at method 550 of FIG. 5B. The operations illustrated in FIG. 5B may, for example, be performed by the collaborative enterprise platform 200, which may include means such the processor 201, the memory 202, input/output circuitry 203, communications circuitry 204, contextually triggered engine circuitry 205, or the like, for applying data analysis.

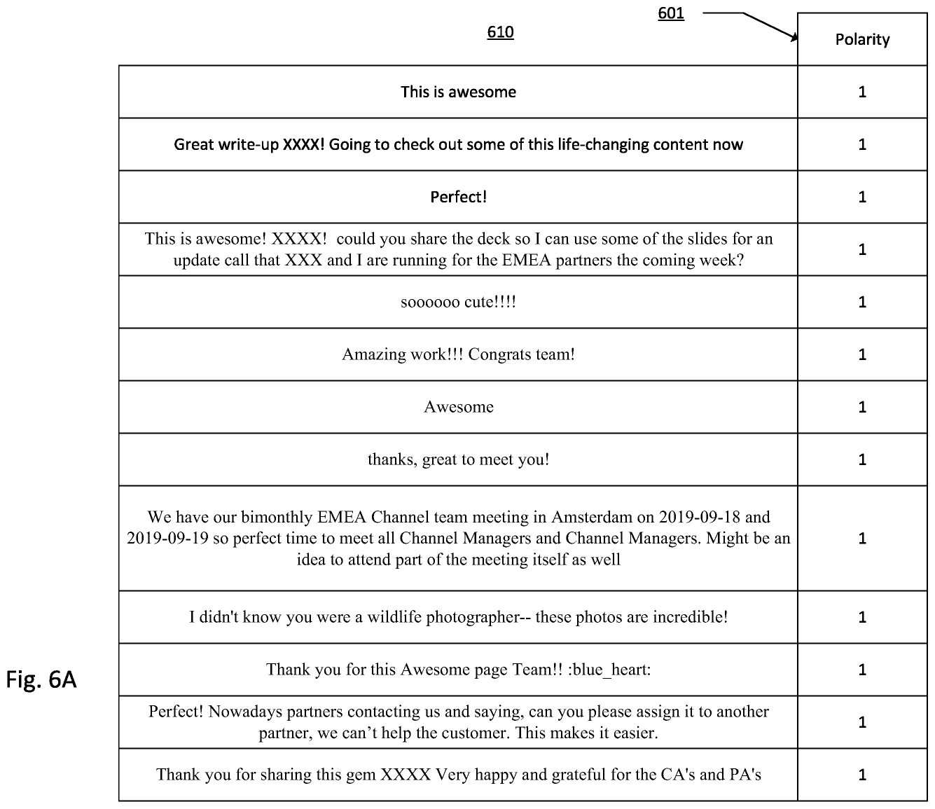

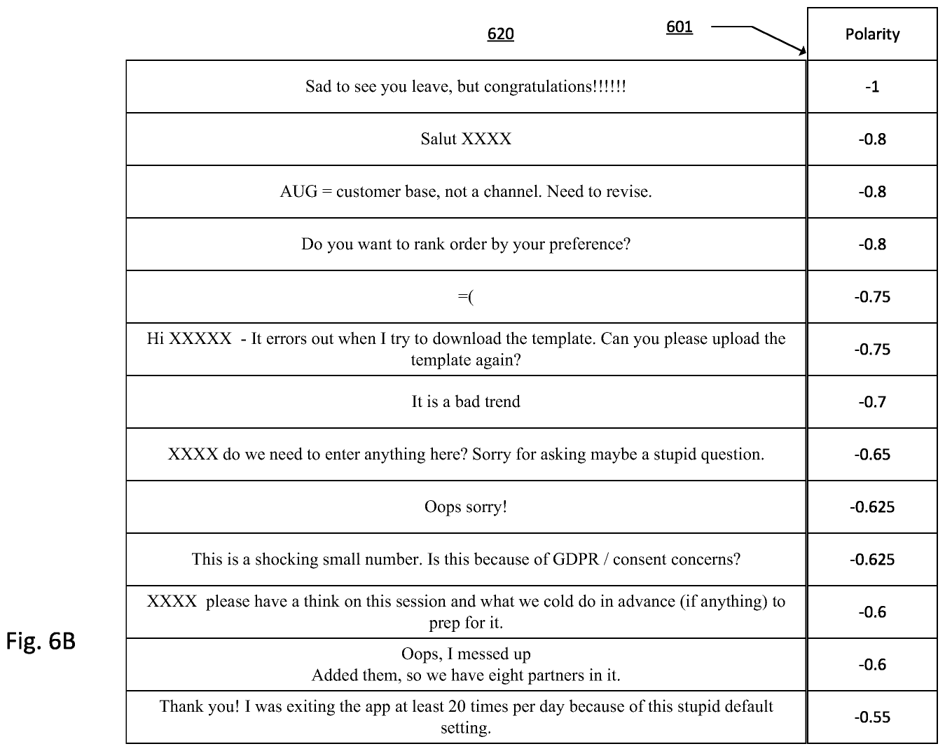

As illustrated in block 504A, in some embodiments, the contextually triggered engine is configured to apply data analysis by accessing sentiment analysis positive and negative polarity datasets. In various embodiments, the contextually triggered engine 210 may be configured to access sentiment analysis positive and negative polarity dataset to determine whether key words found in collected internal collaborative work data and/or external collaborative work-data comprise positive or negative polarity (some examples depicted in FIGS. 6A-6B). The contextually triggered engine 210, with assistance from the trained team health improvement machine learning model, may be configured to determine the polarity values of key words and/or polarity values of tones of internal collaborative work data and/or external collaborative work data.

As illustrated in block 504B, in various embodiments, the contextually triggered engine 210 may determine the positive polarity value and/or negative polarity value of key words within internal collaborative work data and/or external collaborative work data. In various embodiments, the contextually triggered engine 210 may be further configured to calculate an updated polarity value and/or determine whether the team health metric is in a positive polarity and/or a negative polarity. In various embodiments, the contextually triggered engine may use the trained team health improvement machine learning model to monitor the access internal collaborative work data and/or external collaborative work data to determine an updated positive or negative polarity.

As illustrated in block 504C, in various embodiments, the contextually triggered engine 210 and/or the trained team health improvement machine learning model may be configured to update team sentiment polarity number based on new positive and/or new polarity calculations. In various embodiments, the new polarity calculation may be positive if the total polarity of the key words found in internal collaborative work data and/or external collaborative work data are greater than the negative polarity key words found in the internal collaborative work data and/or external collaborative work data. In various embodiments, the trained team health improvement machine learning model may be configured to use the updated polarity value to determine if one or more team improvement intervention components may be needed to be distributed to one or more client devices 102. In some further embodiments, the trained team health improvement machine learning model may display the updated polarity value one or more team assessment interfaces of one or more client devices.

FIGS. 4A, 4B, 5A and 5B that illustrates flow-charts and signal diagrams describing the operations of apparatuses, methods, systems, computer program product according to the example embodiments described above. It should be understood that each flow-block in combination of flow-chart blocks may be implemented by various means such as hardware, firmware, processor, circuitry and/or other devices associated with execution of software including one or more computer program instruction. For example, one or more of the operations described above may be implemented by an apparatus executing computer program instruction. In this regard, the computer program instructions may be stored a memory 202 of the collaborative enterprise platform 200 and may be executed by a processor 201 of the collaborative enterprise platform 200.

As will be appreciated, any such computer program instruction may be loaded onto a computer, or otherwise, programmable apparatus (e.g., hardware) to produce a machine such that the resulting computer or other programmable apparatus implements the function specified in the flow-chart blocks. The computer program instructions can also be stored in a computer-readable memory that may direct a computer or other programmable apparatuses to function in a particular manner, such that the instructions stored in the computer readable memory produce an article of manufacturer, the execution of which implements the function specified in the flow-chart blocks. The computer program instructions may also be loaded onto a computer or other programmable apparatuses to cause a series of operation to be performed on the computer or other programmable apparatus to produce a computer implemented process, such that instruction executed on the computer or other programmable apparatus provide operations for implementing the function specified in the flow-chart blocks.

The flowchart blocks support combinations of means for performing the specified functions and combinations of operations for performing the specified functions. It will be understood that one or more blocks of the flow-charts and combinations of blocks in the flow-charts can be implemented by a special purpose, hardware-based computer systems which performs the specific function or combination of special purpose hardware with computer instructions. These particular embodiments of the subject matter have been described. All the specifications contain specific implementation details.

Thus, particular embodiments of the subject matter have been described. While this specification contains many specific implementation details, these should not be construed as limitations on the scope of any inventions or of what may be claimed, but rather as description of features specific to particular embodiments of particular inventions. Other embodiments are within the scope of the following claims. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

FIG. 6A depicts an example list of an exemplary positive key words and/or positive key tones a machine learning model may be configured to detect throughout collected collaborative work data. In various embodiments, the trained team health improvement machine learning model may be configured to detect/refine positive terms collected from internal collaborative work data and/or external collaborative work data to find positive polarity key words and/or positive polarity key tones in order to update the sentiment polarity number and/or update the trained team health improvement machine learning model.

As depicted in FIG. 6A, a positive polarity list 610 of key words is listed which all have a polarity 601 value of positive 1. In various embodiments, the positive key words and/or positive key tones may all have a polarity of positive value of 1. In some other embodiments, the positive polarity key words and/or positive key tones may not all have the same positive polarity value, but the positive polarity value may not surpass positive 1. As depicted in the positive polarity key word list 610, some example of positive polarity key words and key tones may include awesome, perfect, so cute, amazing work, great to meet you and/or the like. In various embodiments, the trained teamed health improvement machine learning model may be configured to determine positive polarity value of the tone of one or more messages collected from internal collaborative work data and/or external collaborative work data.

FIG. 6B depicts an example list of an exemplary negative key words and/or negative key tones a machine learning model may be configured to detect throughout collected collaborative work data. In various embodiments, the trained team health improvement machine learning model may be configured to detect/refine negative terms collected from internal collaborative work data and/or external collaborative work data to find negative polarity key words and/or negative polarity key tones in order to update the sentiment polarity number and/or update the trained team health improvement machine learning model.

As depicted in FIG. 6B, a negative polarity list 620 of key words is listed which all have a negative polarity value 601 that is less than 0. In various embodiments, the negative key words and/or negative key tones may all have a polarity value of −1. In some other embodiments, the negative polarity key words and/or negative key tones may not all have the same negative polarity value, but the negative polarity value will not exceed zero.

As depicted in the negative polarity key word list 620, some examples of negative polarity key words and key tones may include: sad to see you leave, oops sorry, and/or the like. In various embodiments, the trained teamed health improvement machine learning model may be configured to determine the negative polarity value of the tone of one or more messages collected from internal collaborative work data and/or external collaborative work data.

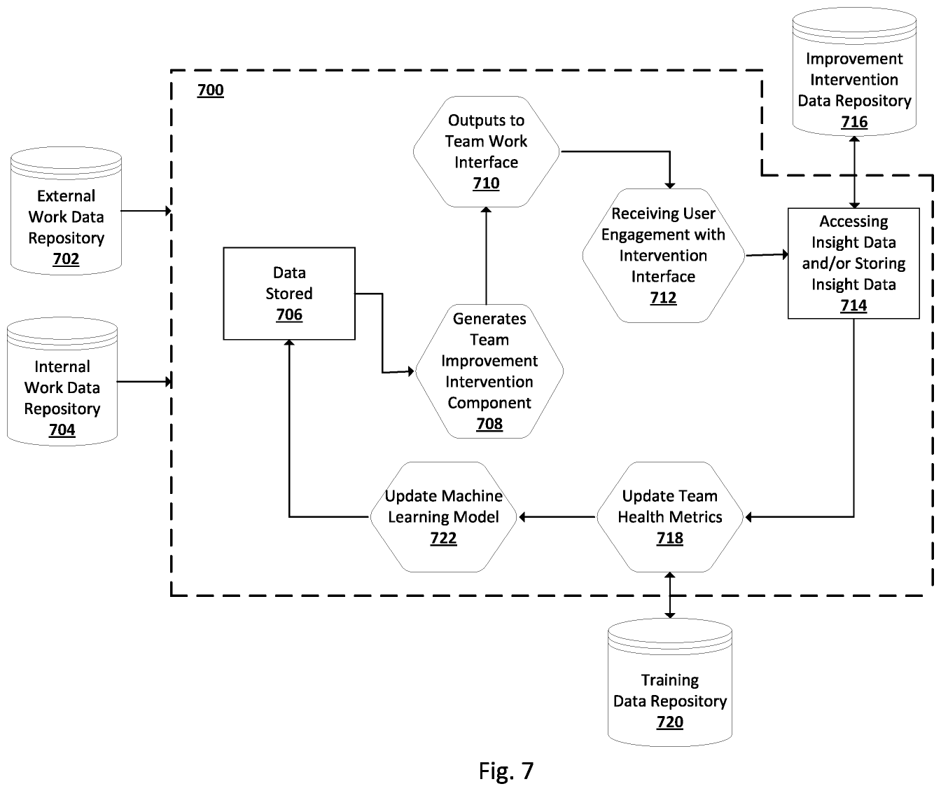

FIG. 7 depicts an example flow diagram depicting operations performed by an example contextually triggered engine 700 for transmitting one or more team improvement intervention components and/or one or more team health metrics dashboards to one or more user devices and/or the updating of the team health metrics based on a user engagement with one or more team assessment interfaces.

In various embodiments, the contextually triggered engine 700 may be configured to receive external collaborative work data from one or more external work data repository 702 and/or internal collaborative work data from one or more internal work data repository 704. The depicted contextually triggered engine 700 is configured to store external collaborative work data and/or the internal collaborative work data to one or more memory devices 202 within an exemplary collaborative enterprise platform 200 as depicted in block 706. In various embodiments, the trained team health machine learning model may configure the contextually triggered engine 700 to generate one or more team improvement intervention components based on the collective data from the external work data repository 702 and/or the internal work data repository 704, as depicted in block 708.

In various embodiments, as depicted in block 710, the trained team health improvement machine learning model configures the contextually trigged engine 700 to output the one or more team improvement intervention component to a team work interface to be displayed on one or more client devices 102A. In one embodiment, for example, the team improvement intervention component may be embodied as a push notification or a pop-up modal that causes a team member or group of team members to engage in a team cohesion exercise.

As illustrated at block 712, as users engage with the team improvement intervention component, they will be generating data associated with the team improvement intervention component and/or data regarding team health metrics (e.g., overall team health, psychological safety, team cohesion, burnout, etc.) that is useful for improving the collaborative enterprise platform. In various embodiments, the contextually triggered engine 700, at block 714, may be configured to access team improvement insight components and other insight data from an improvement intervention data repository and/or store such insight data to an improvement intervention data repository to update one or more team health metrics. In various embodiments, such generated data may be used to produce team improvement insight components and other insight data that may be stored to one or more improvement intervention data repository 716.

In various embodiments, the contextually triggered engine 700 may be configured to use the team improvement insight components and other insight data to update one or more team health metrics as depicted in block 718. In various embodiments, the one or more updated team health metrics may be configured to be stored to one or more training data repositories 720.

In various embodiments, the contextually triggered engine may be configured to update the trained team health machine learning model based, at least in part, on the updated team health metrics, the team improvement insight components, and/or the other insight data. The contextually triggered engine 700 may be further configured to update the trained machine learning model and/or the training dataset to further train the machine learning model on additional data gathered over a defined period or periods from the improvement intervention data repository 716, the internal work data repository 704, and/or the external work data repository 702, as depicted in block 722. In various embodiments, the updated trained team health improvement machine learning model may be stored with the updated insight data and/or the updated team health metrics back to one or more memory 202 of the collaborative enterprise platform 200 as depicted in block 706.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

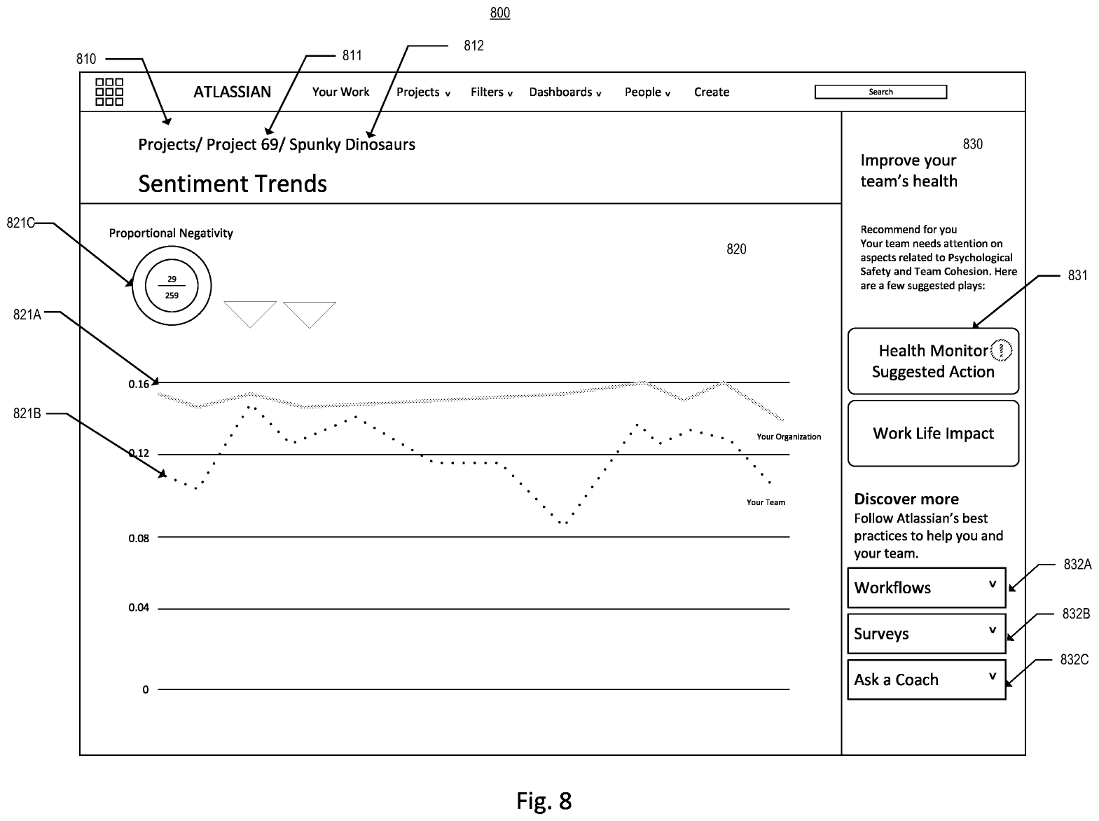

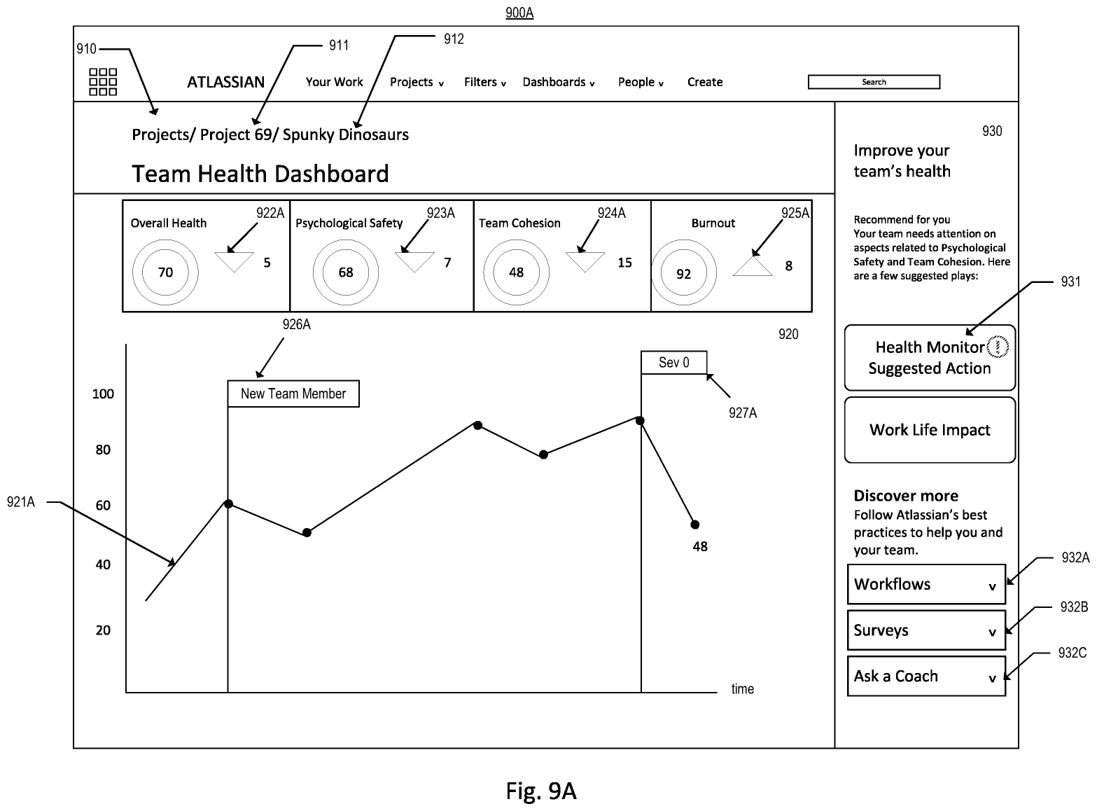

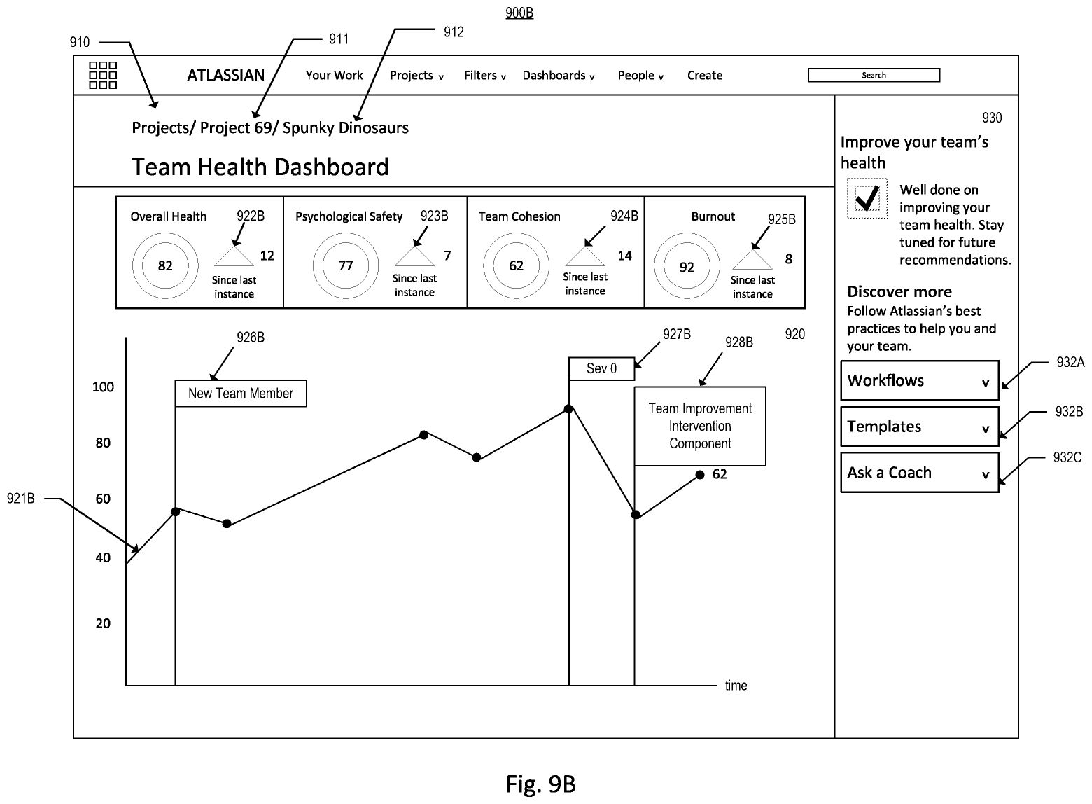

The present embodiments of the present disclosure and apparatus (e.g., collaborative enterprise platform 200, contextually triggered engine 210, one or more client devices 102A) may be configured to output a contextually relevant team metric dashboard to a team assessment interface on one or more client device. FIGS. 8, 9A, and 9B illustrate example of team health metrics displayed on one or more team health metrics dashboard in accordance with various embodiments of the present disclosure.

FIG. 8 depicts an example a team assessment interface 800 that may be configured to display a team health metrics dashboard 820, one or more team improvement insight components 821A-C, and a team improvement intervention component panel 830 in accordance with various embodiments of the present invention. The team assessment interface 800 further includes a project identifier component 810 that indicates a project identifier 811 and team identifier 812.

The depicted team metrics health dashboard 820 include team health metrics defined by organization or enterprise (e.g., Atlassian) and by individual team (e.g., the Spunky Dinosaurs as defined by team identifier 812). For example, the depicted team metrics dashboard 820 includes a first team improvement insight component 821A in the form of a line graph that illustrates how one selected team health metric (e.g., sentiment negativity) changes over time for teams on average within the organization. The depicted team metrics dashboard 820 further includes a second team improvement insight component 821B in the form of a line graph that illustrates how the selected team health metric (e.g., sentiment negativity) changes over time for a selected team (e.g., the Spunky Dinosaurs). The depicted team metrics dashboard 820 further includes a third team improvement insight component 821C illustrating proportional negative sentiment as shown.

The depicted team improvement intervention component panel 830 includes a plurality of team improvement intervention components 831, 832A-C as shown. As discussed in detail above, in various embodiments, the contextually triggered engine is configured to output for display team improvement intervention components when team health metrics or team health metric sets satisfy certain defined team health metrics thresholds.

In other embodiments, although not shown, the contextually triggered engine is configured to output for display team improvement intervention components two team work interfaces of an internal collaboration platform (e.g., Jira) and/or an external collaboration platform (e.g., Slack). One goal of such embodiments is to provide team improvement intervention components for rendering into user interfaces that team member users routinely use to do their work.

In the depicted embodiment, one example team improvement intervention component is a health monitor interface component 831 that leads a team member user to a suggested action for team improvement. For example, in some embodiments, the trained team health improvement machine learning model may configure the contextually triggered engine to identify a suggested team improvement action, among multiple possible suggested team improvement actions, that is most likely to improve one or more team health metrics. Other example team improvement intervention components include an intervention workflows interface component 832A that leads a team member user to team improvement workflows, an intervention surveys interface component 832B that leads a team member user to team improvement surveys, and an ask a coach interface component 832C that triggers a virtual communication session with a team improvement coach.

FIGS. 9A-9B depict example team assessment interfaces 900A, 900B that may be configured to display a team health metrics dashboard 920, one or more team improvement insight components 921A-927A, and a team improvement intervention component panel 930 in accordance with various embodiments of the present disclosure. The team assessment interfaces 900A, 900B further include a project identifier component 910 that indicates a project identifier 911 and team identifier 912.

With reference to FIGS. 9A-9B, in various embodiments, the depicted team health metrics dashboard 920 may be defined by project identifier 911 (e.g., Project 69) and by team identifier 912 (e.g., Spunky Dinosaurs). For example, the depicted team health metrics dashboard 920 includes a first team improvement insight component 921A, 921B in the form of a line graph that illustrates how one selected team health metric (e.g., Team Cohesion) changes over time for a selected team. The depicted team health metrics dashboard 920 further includes a second team improvement insight component 922A, 922B in the form of a circle scoring chart and/or trend arrow that illustrates how one or more additional team health metrics (e.g., overall health) have progressed or trended over the same period of time. The depicted team health metrics dashboard 920 further includes one or more additional team improvement insight component 923A-927A, 923B-928B illustrating different team health metrics (e.g., psychological safety, team cohesion, burnout) and/or the trends associated with such team health metrics over time. In various embodiments, as depicted in FIGS. 9A-9B, a variety of events may be attributed to changes in one or more team health metrics either in a positive manner and/or in a negative manner. In some embodiments, an event that may change one or more team health metric may be a team membership change 926A, 926B, a high severity incident, an objectives and key results change, a managership change, a team vacation, and/or the like.

In still other embodiments, although not shown, team health metrics and team improvement insight components such as those shown could be displayed to a team assessment interface or a team work interface alongside other team related metrics such as, without limitation, work product health, project health metrics, productivity metrics, development velocity, time from code commit to production, time to review code changes, incident response times, and the link. In this way, team member users might be able to draw correlations and confirm the linkage between team health and team performance and productivity.

The depicted team improvement intervention component panel 930 includes a plurality of team improvement intervention components 931, 932A-C as shown. As discussed in detail above, in various embodiments, the contextually triggered engine is configured to output for display team improvement intervention components when team health metrics or team health metric sets satisfy certain defined team health metrics thresholds.

In the depicted embodiment, one example team improvement intervention component is a health monitor interface component 931 that leads a team member user to a suggested action for team improvement. Other example team improvement intervention components include an intervention workflows interface component 932A that leads a team member user to team improvement workflows, an intervention surveys interface component 932B that leads a team member user to team improvement surveys, and an ask a coach interface component 932C that triggers a virtual communication session with a team improvement coach.

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus for configurating a contextually triggered team improvement engine for operation in a collaborative enterprise platform, the apparatus comprising at least one processor, and at least one memory including program code, the at least one memory and the program code configured to, with the at least one processor, cause the apparatus to at least:
access external collaborative work data from a plurality of external collaboration platforms;
access internal collaborative work data from a plurality of internal collaboration platforms;
generate a team health training dataset based on the external collaborative work data and the internal collaborative work data;
train a machine learning model based on the team health training dataset to generate a trained team health improvement machine learning model;
configure the contextually triggered team improvement engine based on the trained team health improvement machine learning model.

2. The apparatus of claim 1, wherein the team health training dataset is generated based on applying sentiment analysis operations and collaboration graph identification operations to the external collaborative work data and the internal collaborative work data.

3. The apparatus of claim 2, wherein the collaboration graph identification operations are configured to generate a collaboration work graph based on the external collaborative work data and the internal collaborative work data, and the machine learning model is trained to generate the trained team health improvement machine learning model based at least in part on the collaboration work graph.

4. The apparatus of claim 1, wherein at least one of the external collaborative work data or the internal collaborative work data comprises team survey data.

5. The apparatus of claim 1, wherein the contextually triggered team improvement engine is configured to monitor user engagement with the collaborative enterprise platform and to generate team improvement insight components for outputting to a team assessment interface.

6. The apparatus of claim 1, wherein the contextually triggered team improvement engine is configured to monitor user engagement with the collaborative enterprise platform and to generate a team improvement intervention component for outputting to a team member client device of the collaborative enterprise platform.

7. The apparatus of claim 6, wherein the team improvement intervention component comprises a survey interface component that is configured for rendering to a team work interface displayed by the team member client device.

8. The apparatus of claim 6, wherein the team improvement intervention component comprises a team improvement workflow interface component that is configured for rendering to a team work interface displayed by the team member client device.

9. The apparatus of claim 1, wherein the contextually triggered team improvement engine is configured to compare a team health metrics set to a team health metric threshold set to generate a team health dashboard metrics set, and to output the team health dashboard metrics set for rendering to a team health dashboard interface of a team assessment interface.

10. A computer-implemented method for configuring a contextually triggered team improvement engine for operation in a collaborative enterprise platform, the computer-implemented method comprising:
accessing at least one of: external collaborative work data from a plurality of external collaboration platforms, or internal collaborative work data from a plurality of internal collaboration platforms;
generating a team health training dataset based on the external collaborative work data or the internal collaborative work data;
training a machine learning model based on the team health training dataset generating a trained team health improvement machine learning model;
configuring the contextually triggered team improvement engine based on the trained team health improvement machine learning model.

11. The computer-implemented method of claim 10, the computer-implemented method further comprising:
generating the team health training dataset based on applying sentiment analysis operations and collaboration graph identification operations to the external collaborative work data or the internal collaborative work data.

12. The computer-implemented method of claim 11, wherein the collaboration graph identification operations are configured to generate a collaboration work graph based on the external collaborative work data or the internal collaborative work data, and the machine learning model is trained to generate the trained team health improvement machine learning model based at least in part on the collaboration work graph.

13. The computer-implemented method of claim 10, wherein at least one of the external collaborative work data or the internal collaborative work data comprises team survey data.

14. The computer-implemented method of claim 10, the computer-implemented method further comprising:
configuring the contextually triggered team improvement engine to monitor user engagements with the collaborative enterprise platform and generate team improvement insight components for outputting to a team assessment interface.

15. The computer-implemented method of claim 10, the computer-implemented method further comprising:
configuring the contextually triggered team improvement engine to monitor user engagements with the collaborative enterprise platform and generate a team improvement intervention component for outputting to a team member client device of the collaborative enterprise platform.

16. The computer-implemented method of claim 15, wherein the team improvement intervention component comprises a survey interface component configured for rendering to a team work interface displayed by the team member client device.

17. The computer-implemented method of claim 15, wherein the team improvement intervention component comprises a team improvement workflow interface component configured for rendering to a team work interface displayed by the team member client device.

18. The computer-implemented method of claim 10, wherein the contextually triggered team improvement engine is further configured to compare a team health metrics set to a team health metric threshold set to generate a team health dashboard metrics set, and to output the team health dashboard metrics set for rendering to a team health dashboard interface of a team assessment interface.

19. A non-transitory computer-readable storage medium for configuring a contextually triggered team improvement engine for operation in a collaborative enterprise platform, the non-transitory computer-readable storage medium including instructions that when executed by at least one processor, cause the at least one processor to:
access external collaborative work data from a plurality of external collaboration platforms;
access internal collaborative work data from a plurality of internal collaboration platforms;
generate a team health training dataset based on the external collaborative work data and the internal collaborative work data;
train a machine learning model based on the team health training dataset to generate a trained team health improvement machine learning model;
configure the contextually triggered team improvement engine based on the trained team health improvement machine learning model.

20. The non-transitory computer-readable storage medium of claim 19, wherein the instructions further cause the at least one processor to:
generate the team health training dataset based on applying sentiment analysis operations and collaboration graph identification operations to the external collaborative work data and the internal collaborative work data.
